(19) United States
(12) Patent Application Publication
(10) Pub. No.: US 2025/0144858 A1
(43) Pub. Date: May 8, 2025

(54) ARTICLE, METHOD OF PRODUCING SAME AND USE OF SAME

(71) Applicant: LEONHARD KURZ Stiftung & Co. KG, Fürth (DE)

(72) Inventor: Nikolas WAGNER, Fürth (DE)

(21) Appl. No.: 18/839,524

(22) PCT Filed: Mar. 1, 2023
(86) PCT No.: PCT/EP2023/055073

§ 371 Date: Aug. 19, 2024

(30) Foreign Application Priority Data
Mar. 3, 2022 (DE) 10 2022 105 006.8

(51) Int. Cl. B29C 45/14; B29C 45/00; B29C 59/04; B29L 31/30; B32B 3/30; B32B 27/06

(52) U.S. Cl. CPC B29C 45/14827; B29C 45/0055; B29C 45/14336; B29C 59/046; B32B 3/30; B32B 27/06; B29C 2045/0058; B29C 2045/14901; B29K 2995/002; B29K 2995/0022; B29K 2995/0026; B29K 2995/0098; B29L 2031/3008; B32B 2307/402; B32B 2307/406; B32B 2307/412; B32B 2307/748; B32B 2605/003

(57) ABSTRACT

A method of producing an article (1), wherein the method includes at least one of the steps A1) or A2) or A3): providing a base body (9), on which a transfer ply (3) and/or a print layer has been arranged, wherein the protective varnish layer (8) and/or the print layer has not yet been completely cured or is thermoplastic at least in regions; and wherein the method comprises the following steps in addition to at least one of the steps A1) or A2) or A3): e) forming at least one first region (5) and at least one second region (6) in the protective varnish layer (8) and/or print layer by means of stamping, wherein the at least one first region (5) has a relief structure; f) optionally curing the protective varnish layer (8) and/or print layer not yet completely cured at least in regions, wherein the protective varnish layer (8) and/or print layer cures completely at least in regions; g) obtaining an article (1).

The invention relates to a method of producing an article, as well as an article and the use of the article.

Films are used for the surface decoration of articles. Articles decorated in such a way are used for example in automotive manufacturing for automotive interior parts such as door trims, instrument panel trims and center console covers, in the field of consumer electronics for decorative trims on televisions or in the electronics and telecommunications field for housing shells for portable devices, for example mobile telephones or laptops, or other cover elements, cladding elements or control elements, for example in domestic appliances.

In order to produce these articles, it is known to back-injection mold IMD transfer films (IMD=In-Mold Decoration) with a plastic material in an injection-molding tool. To guarantee the resistance of articles manufactured in such a way, the IMD transfer films often have protective varnish layers which form an outside of the articles after detachment of a carrier ply of the IMD transfer film.

Further, the surface decoration of articles by means of insert-molding technology is also known. This is a combined method of hot stamping or cold stamping, vacuum forming and injection molding, wherein first a transfer film is applied to a substrate by means of hot stamping or cold stamping, this substrate is deformed, in particular is deep-drawn, three-dimensionally or 2.5-dimensionally once the carrier film has been peeled off the transfer film, and then the substrate is back-injection molded with a plastic material. After the deforming, in particular deep-drawing, it has been provided up to now that the decorated substrate, in particular its outer layers such as protective varnish layers, is cured directly. This curing is effected for example by means of high-energy radiation, for example by means of UV radiation, and is preferably effected by means of irradiation on the decorated substrate side. A curing can alternatively or additionally be effected by means of thermal curing and/or can alternatively or additionally be effected by means of reactive curing inside the layers in question and/or between neighboring layers. In particular, the back-injection molding with the plastic material preferably follows the curing.

Further, the surface decoration of articles by means of wet painting is also known. This is the depositing of liquid varnishes or inks using known methods such as spray-painting, screen printing, inkjet printing, pad printing or the like. Before this wet painting, the article can already have a coating at least in regions, selected individually or in combination from wet painting, transfer coating by means of hot stamping, transfer coating by means of cold stamping, transfer coating by means of IMD methods, coating by means of insert molding, lamination, coextrusion, labelling.

Although it is also known to provide articles with surface structures which occupy the whole surface of the article, for example with matte-finished transfer films, it is desired to provide surface structures only in regions, thus it is necessary to use transfer films which were provided with a post-structuring in regions before they are provided for a method of producing an article. However, this leads to challenges in the subsequent production of the article, in particular when it is desired to bring surface structuring in regions into register with motifs, background colors or other decorative elements of the transfer film and/or with functional regions such as for example control regions and displays or particular regions of the 3D geometry of the decorated part. Furthermore, however, transfer films in which a post-structuring in regions is possible usually have an insufficient resistance to mechanical or chemical strains, precisely because of this structurability.

However, if the surface is to be very robust, a post-processing of the surface is complex and cost-intensive because of its nature and there is the risk that a molding is effected at least partially but does not satisfy all the optical demands. Thus, the result of the post-processing by means of stamping of a, for example, already completely cured and/or crosslinked varnish layer can appear inhomogeneous and blotchy. Furthermore, the robustness of a varnish layer usually also results in a brittleness or a low stretchability, which limits the shapeability of the varnish layer and thus its utility in IMD methods and in-mold methods.

Thus, it is not known to cost-effectively and efficiently provide surfaces which only have a surface structure in regions, wherein on the one hand the surface is very resistant to external influences, such as for example UV radiation, hand creams, solvents, abrasion or scratches, and on the other hand a flexible surface design and the production of three-dimensional or 2.5-dimensional articles is possible.

The object of the invention is now to provide an improved method of producing an article and to provide an improved article, as well as the use thereof.

The object is achieved by a method of producing an article, in particular according to one of claims 1 to 31, wherein the method comprises at least one of the steps A1) or A2) or A3), wherein step A1) comprises the following steps:
a1) providing a transfer film, wherein the transfer film has a carrier ply and a transfer ply, wherein the carrier ply can be peeled off the transfer ply, wherein the carrier ply comprises a carrier layer, wherein the transfer ply comprises a protective varnish layer, wherein the protective varnish layer has not yet been completely cured or is thermoplastic at least in regions and wherein the protective varnish layer has been arranged such that it is in contact with the carrier ply;
b1) arranging the transfer film, in particular the transfer ply, in an injection mold;
c1) back-injection molding the transfer film, in particular the transfer ply, with a plastic material, wherein the plastic material forms a base body;
d) detaching the carrier ply from the transfer ply;
   wherein step A2) comprises the following steps:
a2) providing an insert, wherein the insert has a substrate and, arranged on the substrate, a transfer ply and/or a print layer, wherein the transfer ply comprises a protective varnish layer;
b2) arranging the insert in an injection mold;
c2) back-injection molding the insert with a plastic material, wherein the plastic material forms a base body;
   wherein step A3) comprises the following steps:
a3) providing a transfer film, wherein the transfer film has a carrier ply and a transfer ply, wherein the carrier ply can be peeled off the transfer ply, wherein the carrier ply comprises a carrier layer, wherein the transfer ply comprises a protective varnish layer and wherein the protective varnish layer has been arranged such that it is in contact with the carrier ply,
and providing, separately from the transfer film, a base body, which is in particular produced by means of injection molding;
k3) arranging the transfer film, in particular the transfer ply, on a surface of the base body and hot stamping the transfer film onto the surface of the base body;
d) detaching the carrier ply from the transfer ply;
   wherein the protective varnish layer and/or the print layer has not yet been completely cured or is thermoplastic at least in regions in steps A1) or A2) or A3), and wherein the method comprises the following steps in addition to at least one of the steps A1) or A2) or A3):
e) forming at least one first region and at least one second region in the protective varnish layer and/or in the print layer by means of stamping, wherein the at least one first region has a relief structure;
f) optionally curing the protective varnish layer and/or print layer not yet completely cured at least in regions, wherein the protective varnish layer cures completely at least in regions;
g) obtaining an article, wherein the article comprises a base body and a protective varnish layer and/or print layer, which has been cured or is thermoplastic at least in regions, wherein the protective varnish layer and/or print layer has at least one first region and at least one second region, wherein a relief structure has been arranged in the at least one first region.

The object is further achieved by an article, preferably according to claim 32, wherein the article has a base body and a protective varnish layer and/or a print layer, wherein the protective varnish layer and/or the print layer has been completely cured or is thermoplastic at least in regions, wherein the protective varnish layer and/or the print layer has at least one first region and at least one second region, wherein a relief structure has been arranged in the at least one first region, and wherein the article was produced according to one of claims 1 to 31.

The object is further achieved, in particular by claim 33, through the use of the article according to claim 32 or produced according to a method according to one of claims 1 to 31, alone or in combination, as a display window, touch panel, panel, cover plate, cladding, cover, functional element, electronic article and housing part or outer part, in particular of white goods and/or of domestic appliances and/or of automotive interior regions and/or of automotive exterior regions.

By region is meant here in particular in each case a defined surface area of a layer, film or ply which is occupied when viewed perpendicular to a plane formed by the transfer film, in particular by the transfer ply, the protective varnish layer, the print layer, of the base body and/or of the substrate. Thus, for example, the at least one protective varnish layer and/or the print layer of the obtained article has at least one first region and an at least second region, wherein each of the two or more regions in each case occupies a defined surface area when viewed perpendicular to a plane formed by the protective varnish layer and/or print layer, in particular in all layers arranged in the protective varnish layer and/or print layer and in all layers arranged on top of and/or underneath the protective varnish layer and/or print layer, in particular in all layers of the transfer ply.

By forming at least one region is meant in the present case in particular the manipulation of a layer, a ply or a varnish, for example the protective varnish layer and/or print layer, wherein the surface structure of the original layer, the ply or of the varnish, for example the protective varnish layer and/or print layer, then differs from the surface structure, in particular relief structure, of the manipulated region. The regions are in particular formed in the layer, the ply or the varnish, for example in the protective varnish layer and/or print layer, wherein in particular the surface structure of the layer, the ply or the varnish is more structured in the manipulated region. Thus, it can be the case that no surface structure, in particular no relief structure, is present in the in the layer, the ply or the varnish, for example in the protective varnish layer and/or print layer, before the forming of the at least one region and a surface structure, in particular relief structure, has been formed in the at least one manipulated region after the forming. It is thus possible for the at least two formed regions to differ optically. This difference is in particular perceptible for the human eye and/or measurable for a sensor. The forming of the regions is preferably effected by means of stamping.

“Not yet completely cured” preferably describes a layer, in particular the protective varnish layer and/or print layer, when its hardness and/or resistance does not yet have a fixed minimum value. The fixed minimum value of the hardness and/or of the resistance is preferably a function of the ultimate intended use of the layer, for example as a protective varnish layer and/or print layer. “Completely cured” within the meaning of the present invention therefore describes a layer when its hardness and/or resistance has a fixed minimum value.

It is possible for the above-named minimum values to have been fixed such that a layer is described as not yet completely cured within the meaning of the present invention when not more than 95% of the polymer constituents of the layer that are capable of crosslinking have a crosslinking. A layer is therefore described as completely cured within the meaning of the present invention when more than 95% of the polymer constituents of the layer that are capable of crosslinking have a crosslinking. A completely cured layer is present when a complete (>95%) crosslinking of its polymer constituents has been effected.

The present method makes it possible to provide transfer films with a relief structure only in regions by means of stamping only after an injection-molding process. This provides several advantages. Thus, during the production of an article there is no need to provide a film which already has a relief structure in regions. As a result, the method also has no risk of obtaining an unintentional offset of the relief structure in regions relative to decorative elements or functional elements.

The present invention makes it possible to provide articles which have a surface resistant to mechanical and chemical influences and have nevertheless been structured with a relief structure in regions. This can be achieved in that layer structured in regions obtains its provided strength only during the method. This further makes it possible to produce three-dimensionally or 2.5-dimensionally shaped articles, as the transfer film has a sufficient flexibility during the shaping process. However, it is also possible for the transfer film to undergo no or only a very slight shaping and to be applied to a flat (2D, two-dimensional) region.

Further, because of the use of different and replaceable stamping tools or carriers comprising a master structure, it is made possible to create individual layouts for the articles. Thus, the creation of small quantities or even individual items is also associated with much lower additional costs than when specifically already structured transfer films have to be manufactured. Furthermore, last-minute changes in the layout can also be made. Thus, no transfer films need to be disposed of unused when their layout is no longer current at short notice.

A further big advantage over the known state of the art is that structures and/or motifs that can possibly be backlit in the article and/or in the transfer film are not or are only insignificantly influenced by the post-structuring. The post-structuring influences the locally present transparency only to a small degree. Thus, the scattering effect introduced by the relief structure is so low that it is negligible in transmitted light. It is hereby possible to stamp optically diffractive structures which have been designed for an illumination in transmission. If the article is provided with backlighting, then additional optical effects, for example anti-glare effects, can moreover be brought about by the relief structures introduced only in regions.

Further advantageous designs of the invention are described in the dependent claims.

Steps A1) and A2) and A3) describe in particular equivalent alternatives for obtaining and/or providing a base body on which a transfer ply and/or a print layer has been arranged, wherein the the protective varnish layer and/or the print layer has not yet been completely cured or is thermoplastic at least in regions. Step A1) comprises at least the steps a1), b1), c1) and d). Step A2) comprises at least the steps a2), b2) and c2). Step A3) comprises at least the steps a3), k3) and d).

In particular in steps e), f) and g), it is described how an article is obtained from the base body, preferably after steps A1) and/or A2) and/or A3), on which a transfer ply and/or a print layer has been arranged. The article here has a base body and a protective varnish layer and/or a print layer, wherein the protective varnish layer and/or the print layer has been cured or is thermoplastic at least in regions, and wherein the protective varnish layer and/or the print layer has at least one first region and at least one second region, wherein a relief structure has been arranged in the at least one first region.

By step a) is meant step a1), a2) and/or a3). Further, by step b) is meant step b1) and/or b2). Further, by step c) is meant step c1) and/or step c2).

Step a) is preferably the first step of the method and is carried out in particular before steps b) to g). In step a) it is possible for the transfer film to be provided in rolls. Further, it is possible for the transfer film to be provided as a hot-stamping film or as an IMD film. Further, it is possible for an insert to be provided. The article is preferably produced in an IMD method or an insert-molding method. It is also possible for the article to be produced in an injection-molding method with a downstream hot-stamping method, wherein the transfer ply is arranged on a base body in the hot-stamping method. In particular in step a3) a base body, which can preferably have been designed like the base body described in relation to step c), is provided in addition to the transfer film.

A transfer film provided in step a) or a provided insert can have a transfer ply, which has been constructed multi-layered.

It is possible for a provided insert to have a multi-layered transfer ply and/or a multi-layered print layer. The print layer has preferably been arranged on the insert partially or over the whole surface. The print layer has been formed in particular as a screen print layer, as a gravure print layer, as an inkjet print layer or as a combination thereof. The insert preferably has a gravure print layer and a screen print layer. It is possible for the layers of the print layer to overlap at least partially. It is possible for the insert to have a transfer ply, on which one or more print layers have been partially printed.

The transfer ply preferably has a layer thickness selected from a range of from 0.1 μm to 100 μm, preferably from 0.5 μm to 75 μm, further preferably from 1 μm to 50 μm.

The protective varnish layer and/or the print layer protects the finished article in particular from external influences such as UV radiation, mechanical influences, for example scratches, or chemical influences, for example creams or solvents. The protective varnish layer and/or print layer thus has in particular a high resistance to mechanical and chemical strains, in particular compared with the layers lying underneath it, the base body and/or the optional substrate.

The protective varnish layer preferably has a layer thickness selected from a range of from 1 μm to 15 μm, preferably from 2 μm to 8 μm, further preferably from 2 μm to 5 μm. With such a layer thickness of the protective varnish layer it is possible for the protective varnish layer to have the necessary resistance in the finished article.

Further, the protective varnish layer has in particular a transmittance of at least 70%, preferably of at least 85%, for the wavelength range perceptible by the human eye, preferably for the range from 400 nm to 700 nm. By the above transmittances is meant that the protective varnish layer is transparent. A decoration, decorative element or base body lying underneath it is hereby clearly recognizable.

In particular, the protective varnish layer has not yet been completely cured at least in regions. Preferably, the protective varnish layer has been precured chemically and/or by means of irradiation, preferably UV irradiation, at least in regions and/or is still completely curable by means of irradiation, preferably UV irradiation, at least in regions. For this purpose, the protective varnish layer has at least one UV-crosslinkable polymer. A UV-crosslinkable polymer within the meaning of the invention preferably has at least one, preferably two or more, ethylenically unsaturated double bond(s).

The term “ethylenically unsaturated double bond” preferably means a mono-, di- or trisubstituted C═C double bond which is not integrated in an aromatic electron system. An ethylenically unsaturated double bond is preferably not conjugated with other double bonds.

The protective varnish layer not yet cured in regions has preferably been produced on the basis, alone or in combination, of at least one UV-crosslinkable or at least one chemically crosslinkable polymer. Further, the protective varnish layer can have been produced from thermoplastic polymer.

It is possible for the protective varnish layer furthermore to have at least one chemically crosslinkable polymer, which is further preferably selected from the group which consists of isocyanate-group-containing polymers, melamine-containing polymers, hydroxyl-group-containing polymers and mixtures thereof.

The protective varnish layer preferably has at least one chemically crosslinkable polymer combination, which comprises or is a polymer and/or copolymer with at least one, preferably two or more, isocyanate group(s) and at least one polymer and/or copolymer with at least one, preferably two or more, hydroxyl group(s) and/or at least one melamine resin and at least one polymer and/or copolymer with at least one, preferably two or more, hydroxyl group(s).

It is further possible for the at least one UV-crosslinkable polymer of the protective varnish layer furthermore to have, in each case independently of one another, at least one chemically crosslinkable functional group, wherein the chemically crosslinkable functional group is preferably selected from hydroxyl group, isocyanate group, melamine group, epoxide group and combinations thereof.

Preferably, the at least one UV-crosslinkable polymer furthermore has at least one hydroxyl group.

Suitable UV-crosslinkable hydroxyl-group-containing polymers are known from the state of the art and comprise for example at least one diacrylate monomer, aliphatic polyether urethane diacrylate, aliphatic polyester urethane diacrylate, aromatic polyether urethane diacrylate, aromatic polyester urethane diacrylate, polyester diacrylate, polyether diacrylate, epoxy diacrylate, acrylated acrylic diacrylate, polyacrylate monomer, aliphatic polyether urethane polyacrylate, aliphatic polyester urethane polyacrylate, aromatic polyether urethane polyacrylate, aromatic polyester urethane polyacrylate, polyester polyacrylate, polyether polyacrylate, epoxy polyacrylate, acrylated acrylic polyacrylate or mixtures thereof and/or at least one hydroxy monoacrylate, hydroxy diacrylate, hydroxy polyacrylate, hydroxy-functionalized aliphatic polyether urethane monoacrylate, hydroxy-functionalized aliphatic polyester urethane monoacrylate, hydroxy-functionalized aromatic polyether urethane monoacrylate, hydroxy-functionalized aromatic polyester urethane monoacrylate, hydroxy-functionalized polyester monoacrylate, hydroxy-functionalized polyether monoacrylate, hydroxy-functionalized epoxy monoacrylate, hydroxy-functionalized acrylated acrylic monoacrylate, hydroxy-functionalized aliphatic polyether urethane diacrylate, hydroxy-functionalized aliphatic polyester urethane diacrylate, hydroxy-functionalized aromatic polyether urethane diacrylate, hydroxy-functionalized aromatic polyester urethane diacrylate, hydroxy-functionalized polyester diacrylate, hydroxy-functionalized polyether diacrylate, hydroxy-functionalized epoxy diacrylate, hydroxy-functionalized acrylated acrylic diacrylate, hydroxy-functionalized aliphatic polyether urethane polyacrylate, hydroxy-functionalized aliphatic polyester urethane polyacrylate, hydroxy-functionalized aromatic polyether urethane polyacrylate, hydroxy-functionalized aromatic polyester urethane polyacrylate, hydroxy-functionalized polyester polyacrylate, hydroxy-functionalized polyether polyacrylate, hydroxy-functionalized epoxy polyacrylate, hydroxy-functionalized acrylated acrylate or mixtures thereof.

As melamine resins, in particular, those which can be obtained by reacting melamine with aldehydes and possibly can be partially or completely modified are suitable.

In particular, formaldehyde, acetaldehyde, isobutyraldehyde and glyoxal are suitable as aldehydes.

Melamine formaldehyde resins are preferably reaction products of the reaction of melamine with aldehydes, for example the above-named aldehydes, in particular formaldehyde. The methylol groups obtained are preferably modified by etherification with mono- or polyhydric alcohols.

It is further possible for the protective varnish layer to have precured systems and/or hybrid systems. It is possible in particular for the protective varnish layer to have at least one UV-curable component consisting of UV-curable monomers and/or UV-curable oligomers or mixtures thereof and furthermore to have at least one binder, which is selected from the group which consists of polyurethanes, polyacrylates, polymethacrylates, polyester resins, polycarbonates, phenolic resins, epoxy resins, polyureas, melamine resins, preferably polymethyl methacrylate (PMMA), polyester, polycarbonate (PC) and mixtures thereof.

It is further possible for the protective varnish layer preferably to comprise at least one polyisocyanate. The term polyisocyanate preferably describes an organic compound with two or more isocyanate groups, including triisocyanates and higher-functional isocyanates.

In particular embodiments, the at least one polyisocyanate is selected from the group which consists of diisocyanate monomer, diisocyanate oligomer, diisocyanate-terminated prepolymer, diisocyanate-terminated polymer, polyisocyanate monomer, polyisocyanate oligomer, polyisocyanate-terminated prepolymer, polyisocyanate-terminated polymer, polyisocyanate-terminated polymer and mixtures thereof.

Further preferably, the at least one polyisocyanate comprises or is at least one diisocyanate-containing component, which preferably contains at least one diisocyanate-containing polyurethane oligomer, diisocyanate-containing polyurea oligomer, prepolymers thereof, polymer thereof or mixtures thereof.

In particular embodiments, the at least one polyisocyanate comprises or is at least one diisocyanate-containing component, which is preferably selected from the group which consists of hexamethylene diisocyanate (HDI), isophorone diisocyanate (IPDI), methylene diphenyl diisocyanate (MDI), toluene diisocyanate (TDI), phenylene diisocyanate, naphthalene diisocyanate, diphenyl sulfone diisocyanate, ethylene diisocyanate, propylene diisocyanate, dimers of these diisocyanates, trimers of these diisocyanates, triphenylmethane triisocyanate, polyphenylmethane polyisocyanate (polymeric MDI) and mixtures thereof.

The protective varnish layer preferably is or comprises a dual-cure system, preferably for example based on a hydroxyl-containing polyacrylic acrylate crosslinked with melamine resin. A dual-cure system can in particular be cured in two curing steps, which is based on a combination of a chemical crosslinking and a curing of UV-crosslinkable polymers.

It is possible in particular for the protective varnish layer to have been produced on the basis of a system which dries physically and is crosslinkable chemically and/or by means of UV irradiation. The protective varnish layer of the transfer film, preferably transfer ply, is preferably cured during the method of producing the article by chemically crosslinking and/or interlinking the protective varnish layer.

The protective varnish layer can preferably have additives, for example selected, alone or in combination, from pigments, initiators, crosslinkers or catalysts. In particular, the initiators are photoinitiators. It is hereby possible to start, support and/or control the curing of the protective varnish layer.

It is possible for the protective varnish layer of the transfer film, preferably the transfer ply, to be based on a thermoplastic polymer and/or a thermoplastic resin. It is thus possible for the protective varnish layer preferably not to be crosslinkable or crosslinked chemically and/or not to be crosslinkable or crosslinked by means of UV radiation. The thermoplastic polymer and/or the thermoplastic resin can for example be selected, alone or in combination, from the group of the polyurethanes, polyacrylates, polymethacrylates, polyester resins, polycarbonates, styrene-butadiene copolymers, preferably be selected, alone or in combination, from the group polymethyl methacrylate (PMMA), polyester, polycarbonate (PC), polycarbonate/acrylonitrile butadiene styrene (PC/ABS).

In a preferred embodiment the protective varnish layer has been formed as a print layer, in particular as a screen print layer, as a gravure print layer, as an inkjet print layer or as a combination thereof. Here, the protective varnish layer preferably has a transmittance of at most 30%, preferably of at most 15%, for the wavelength range perceptible by the human eye, preferably for the range from 400 nm to 700 nm. By the above transmittances is meant that the protective varnish layer is not transparent. It is hereby possible for the protective varnish layer to be perceived as a decoration and/or decorative element, preferably for the protective varnish layer to form a decoration and/or decorative element.

It is possible for the protective varnish layer to have been arranged in the transfer ply partially or over the whole surface, preferably for the protective varnish layer to have been arranged in the transfer ply over the whole surface. It is possible for the protective varnish layer to have been formed multi-layered, in particular wherein the layers of the protective varnish layer overlap at least partially. This is advantageous in particular if the the protective varnish layer has been formed as a print layer, as interesting designs can be generated hereby.

It is possible for a print layer, in particular a further print layer and/or the above-described print layer of the insert, to have been and/or to be arranged on the protective varnish layer, in particular wherein the print layer has not yet been completely cured at least in regions. This print layer, in particular this further print layer and/or the above-described print layer of the insert, has been and/or is arranged on the protective varnish layer preferably partially or over the whole surface. Further, this print layer, in particular this further print layer and/or the above-described print layer of the insert, has been formed in particular as a screen print layer, as a gravure print layer, as an inkjet print layer or as a combination thereof, preferably as a screen print layer.

The transfer ply has in particular at least one decorative layer containing at least one decorative element, preferably on the side of the protective varnish layer facing away from the carrier ply.

Further, the at least one decorative element containing by the at least one decorative layer is preferably selected from the group which consists of transparent and/or colored varnish layers, in particular comprising one or more dyes and/or pigments, replication layers with a molded optically active surface structure, reflective layers, in particular opaque reflective layers, transparent reflective layers, metallic reflective layers or dielectric reflective layers, optically variable layers, optically active layers, interference multilayer systems, volume hologram layers, liquid crystal layers, in particular cholesteric liquid crystal layers, and combinations thereof.

Alternatively or additionally, it is possible for the transfer ply to have at least one functional layer containing at least one functional element on the side of the protective varnish layer facing away from the carrier ply. It is possible here for at least one functional layer to have been arranged overlapping and/or neighboring at least one decorative layer. It is also possible for at least one functional layer to have been arranged between at least two decorative layers or to have been arranged on a side of the functional layer of at least one decorative layer facing and/or facing away from the protective varnish layer.

The at least one functional element is in particular selected from the group which consists of at least one electronic element, in particular a strip conductor, contact element, LED, sensor, in particular touch sensor, temperature sensor, pressure sensor, antenna, in particular RFID element, memory, processor, control element, display, capacitor, resistor, microfluidic element and combinations thereof.

For example, the functional layer, alone or in combination, can be designed as electrically conductive layers, antenna layers, electrode layers, magnetic layers, magnetic memory layers or barrier layers.

Preferably, the at least one decorative element has been arranged in at least one decorative layer and/or the at least one functional element has been arranged in at least one functional layer, which comprise, in each case independently of one another, a UV-crosslinked varnish or chemically crosslinked varnish or a thermoplastically deformable layer and which are, in each case independently of one another, unpigmented or pigmented or dyed.

It is also conceivable that the protective varnish layer preferably has at least one decorative element and/or a functional element or for example none of these at least partially.

An adhesion-promoter layer has preferably been arranged between the protective varnish layer and the at least one decorative element and/or the at least one functional element. It is possible here for the adhesion-promoter layer to comprise or consist of at least one acrylic resin. Further, it is possible for the adhesion-promoter layer preferably to have a layer thickness selected from a range of from 0.1 μm to 10 μm.

It is also possible for the transfer ply to have at least one varnish layer, preferably with a layer thickness selected from a range of from 0.5 μm to 10 μm, which forms a surface of the transfer ply facing away from the carrier ply. This varnish layer is preferably used for joining to the base body or the plastic material. The at least one varnish layer preferably comprises or consists of at least one adhesive, which is selected from the group which consists of physically curing adhesives, chemically curing adhesives, pressure-sensitive adhesives or mixtures thereof. Further, it is possible for the at least one varnish layer to be a primer layer and/or for a primer layer to have been arranged in place of the at least one varnish layer and/or for a primer layer to have been arranged on the side of the at least one varnish layer facing away from the protective varnish layer, in particular wherein the primer layer comprises or consists of PVC copolymers and PMMA (PVC=polyvinyl chloride, PMMA=polymethyl methacrylate).

Further, the transfer ply can have at least one or more of the following layers, selected in each case individually or in combination from: at least one colored varnish layer, at least one metal layer, at least one oxide layer, at least one barrier layer, at least one receiving layer, at least one second protective varnish layer, at least one laser protective varnish layer. The layers can have been arranged in the transfer ply in each case over the whole surface or in each case partially.

The carrier layer of the transfer film is provided with a carrier ply, which preferably comprises, alone or in combination, polyethylene terephthalate (PET), glycol-modified polyethylene terephthalate (PETG), polypropylene (PP), polycarbonate (PC), polyimide (PI) or polyamide (PA), and/or blends or copolymers thereof. The carrier ply, preferably the carrier layer, preferably has a layer thickness selected from the range of from 10 μm to 100 μm, preferably from 10 μm to 50 μm.

It is possible for the carrier ply to have at least one detachment layer, which has preferably been arranged between the carrier layer and the protective varnish layer. The layer thickness of the detachment layer is in particular selected from a range of from 0.1 nm to 100 nm. The detachment layer preferably comprises or consists of at least one wax, for example a polyethylene wax. The detachment layer preferably has a melting temperature selected from a range of from 80° C. to 100° C. The carrier ply has preferably been arranged on the protective varnish layer with an adhesive force in a range of from 2 cN to 50 cN, preferably in a range of from 5 cN to 35 cN, or this force needs to be overcome when the carrier ply is peeled off.

“In contact with the carrier ply” means, in relation to the protective varnish layer, that the protective varnish layer is in direct contact with the carrier layer of the carrier ply when no detachment layer has been provided or means, when a detachment layer has been provided, that the protective varnish layer is in contact with the detachment layer of the carrier ply.

It is further conceivable that the transfer film is arranged on a substrate, is shaped, preferably pre-deformed and/or deep-drawn, and/or trimmed before step b) and in particular before step d). Here, it is advantageous in particular if the protective varnish layer has not yet been cured at least in regions, as it then has a much greater stretchability.

In other words, it is possible for the method further to comprise at least one of the following steps h), i) and j):
h) arranging the transfer film on a substrate;
i) shaping the transfer film and/or the substrate into a desired shape; and
j) trimming the transfer film and/or the substrate along a defined contour line.

In particular, it is possible for steps h), i) and j) to be carried out after step a), preferably after step a1). Step h) is preferably carried out before step d). Steps i) and j) are preferably carried out after step d) and preferably before step b).

It may also be appropriate to carry out steps h), i) and j) before step d). This provides the advantage that the protective varnish layer is still protected by the carrier ply during the back-injection molding, in particular if only a slight shaping is carried out in step i).

Steps h), i) and j) are carried out in particular in an insert-molding method, wherein the transfer film arranged on the substrate corresponds to an insert or can be used as an insert. It is possible for the insert to be able to be used as and/or correspond to the insert provided in step a2). In other words, the insert provided in step a2) can be obtained after step i). For this purpose, the insert can be laid in an injection mold in a subsequent method step, in particular step b), and can in particular be back-injection molded there preferably in step c).

In particular, the arranging of the transfer film on a substrate is effected by means of stamping, in particular hot stamping or cold stamping. The arranging of the transfer film is preferably effected by application of heat and/or pressure and/or irradiation by means of UV radiation.

In particular, the substrate is selected, alone or in combination, from polycarbonate (PC), polycarbonate/acrylonitrile butadiene styrene (PC/ABS), polypropylene (PP), thermoplastic polyurethane (TPU), polymethyl methacrylate (PMMA), or blends and/or coextrudates thereof.

In particular, the shaping can be effected, alone or in combination, by deep drawing or vacuum forming. The shaping is preferably effected by application of heat and/or pressure.

In particular, the trimming can be effected, alone or in combination, by means of waterjet cutting, lasering or punching.

The transfer ply is arranged in an injection mold in step b) and back-injection molded with a plastic material in step c). Step b) is preferably carried out after step a) or after step j) and in particular before step c). Step c) is preferably carried out before step d) and/or after step b). In particular, step c) can be carried out once or multiple times, in particular wherein identical or different plastic materials are used.

The injection mold expediently has the shape of the surface of the article and/or predefines it. It is possible to obtain an article which is a rigid body. It is preferably possible for the surface of the article, in particular with the protective varnish layer, to be curved and/or bent.

During the back-injection molding of the transfer ply, in particular in step c), the transfer ply or optionally the substrate is preferably covered with the plastic material at least in regions on at least one surface of the transfer ply of the transfer film facing away from the carrier ply. For this purpose, the transfer film is arranged in the injection mold and the injection mold is filled with at least the plastic material. Further, it is possible for the injection mold to be formed of two mold halves, in particular which have been opened before step b) and are closed before step c), preferably wherein the injection mold is formed.

The base body is formed of the plastic material and comprises the plastic material. The plastic material preferably comprises thermoplastic plastic, selected individually or in combination from polycarbonate (PC), polyethylene therephthalate (PET), polypropylene (PP), polymethyl methacrylate (PMMA), polyethylene naphthalate (PEN), polyamide (PA), acrylonitrile butadiene styrene copolymer (ABS), ABS/PC, PC/ABS and thermoplastic polyurethane (TPU). The base body can be formed single-layered or multi-layered.

It is further possible for the base body to have a transmittance of at least 45%, preferably of at least 70%, for the wavelength range perceptible by the human eye, preferably for the range from 400 nm to 700 nm. For example, displays or light sources can hereby be perceived through the base body. This provides the advantage that a produced article can be backlit.

After the plastic material has cooled or after the base body has been formed, the base body and the transfer film are advantageously removed from the mold. In particular, the transfer film and/or optionally the substrate has been joined to the base body after step c). The transfer ply and/or the substrate can no longer be removed from the base body in a destruction-free manner.

The carrier ply is detached from the transfer ply in step d). Step d) is preferably carried out before step e). In particular, step d) can be carried out before step f), and before step g). Further, step d) is preferably carried out after step c). It is possible for step d) to be carried out after step k3).

A possibly present detachment layer can remain on the carrier ply or remain on the transfer ply when the carrier ply is removed. Further, it is also possible for the detachment layer to break up, with the result that after the carrier ply has been removed residues of the detachment layer are arranged on the carrier ply and on the transfer ply.

It is further possible for the back-injection molding of the transfer ply in step c) and the detachment of the carrier ply in step d) to be carried out with a spatial separation. It is possible here for the transfer ply joined to the base body to be stored temporarily and/or transported. In particular at another production location, it is then possible to individualize the article by means of forming the at least one first and/or second region.

The transfer film, in particular the transfer ply, is arranged on a surface of the base body in step k3) of step A3). Further, the transfer film, preferably the transfer ply, is joined to the surface of the base body by means of hot stamping. The transfer ply can preferably no longer be removed from the base body in a destruction-free manner. It is further possible for the transfer ply to be and/or to have been arranged on the base body partially or over the whole surface.

At least one first region and at least one second region are arranged in the protective varnish layer and/or in the print layer in step e). This is effected by means of a stamping method, for example hot stamping, in particular roll stamping or up-and-down stamping, preferably by contacting the protective varnish layer and/or the print layer with a stamping tool. For example, the stamping tool can have a master structure on the surface which is contacted with the protective varnish layer and/or with the print layer.

The master structure on the surface of the stamping tool can have been introduced for example by laser machining and/or by etching methods and/or by means of other known surface treatment methods.

In a further embodiment variant it is possible for a carrier comprising a master structure to be arranged between a stamping tool and the transfer ply and/or between a stamping tool and the print layer at least in regions. In other words, it is possible for the stamping tool to be able to have a carrier comprising a master structure at least in regions. In this case, the stamping tool preferably has no master structure and/or is smooth and preferably predefines only with a contour of the stamping surface as outer contour and possibly predefines the stamping surface with one or more recesses inside the outer contour as inner contour. It is thus possible for the outer contour and preferably the inner contour of the stamping surface to be predefined by the stamping tool.

Alternatively, the stamping tool can have an additional master structure in addition to the master structure of the carrier, wherein the master structure of the stamping tool and the master structure of the carrier then overlap in the protective varnish layer and/or in the print layer, in particular in the at least one first region. The master structure of the stamping tool and of the carrier are preferably different here. For example, for this purpose the master structure on the stamping tool has a different dimension from the master structure on the carrier. For example, the stamping tool predefines a coarse structure in the millimeter to micrometer range and the master structure on the carrier as a fine structure in the micrometer to nanometer range is superimposed thereon, wherein a combination structure of coarse structure and fine structure is molded in the protective varnish layer and/or in the print layer.

Through the contacting of the stamping tool with the protective varnish layer and/or with the print layer and/or the carrier arranged in between, the master structure of the stamping tool or of the carrier is at least partially molded in the protective varnish layer and/or in the print layer, wherein a relief structure complementary to the master structure is reproduced in the protective varnish layer and/or in the print layer, in particular in the at least one first region.

In particular, the protective varnish layer and/or the print layer is contacted with the stamping tool or the carrier only in regions, preferably only where at least one first region is arranged in the protective varnish layer and/or in the print layer.

It is also possible for the stamping tool and/or the carrier to have been designed such that the stamping tool and/or the carrier has a master structure only in regions, wherein the protective varnish layer and/or the print layer is contacted with the stamping tool and/or the carrier such that the master structure contacts the protective varnish layer and/or the print layer where at least one first region is arranged in the protective varnish layer and/or in the print layer. Alternatively or additionally, the regions of the protective varnish layer and/or of the print layer in which the at least one second region is arranged can have been covered with an in particular detachable mask, for example a detachable polymer film.

Step e) is preferably effected using a stamping tool. For example, at least one stamping roller or at least one stamping wheel or at least one die stamp and/or at least one carrier comprising a master structure can be used as stamping tool.

On the surface which is contacted with the protective varnish layer and/or print layer, for example its outer circumference, the stamping tool preferably has a coating of an elastomer with a layer thickness selected from a range of from 3 mm to 20 mm, preferably from 5 mm to 15 mm. The elastomer is preferably silicone rubber. The elastomer preferably has a hardness selected from the range of from 30 Shore A to 95 Shore A, preferably from 60 Shore A to 90 Shore A. The optical properties of the relief structure of the at least one first region can advantageously be influenced by the different Shore hardnesses.

Alternatively, it is also possible for the stamping tool to have a surface made of metal, in particular which is selected from the group of brass, copper, steel or titanium.

On the circumference on its outer edges in each case the stamping wheel preferably has a bevel, wherein in particular the coating of an elastomer on the circumference on the outer edges has a bevel in each case. The bevel preferably has an angle relative to the surface normal of the circumference of the stamping wheel of between 15° and 75°, further preferably between 25° and 65°. Particularly clean edges of the stamping can be achieved with such a bevel. This means that the transition between the first region and the neighboring second region is largely smooth, largely straight and largely without disruptive artifacts, in particular is smooth, straight and largely without disruptive artifacts, for the unaided human eye.

The forming of the at least one first and second regions is preferably effected at a stamping temperature, thus the temperature of the stamping tool, selected from a range of from 125° C. to 250° C. The above temperature range guarantees a clear impression of the relief structure, without the carrier or the layers of the transfer ply being damaged by the temperature.

Further, the stamping speed, thus the feed rate, has a value selected from a range of from 1 m/min to 5 m/min.

The stamping pressure, in particular in the case of up-and-down stamping, is preferably selected from a range of from 0.1 kN to 25 kN, preferably from 0.2 kN to 20 kN, particularly preferably from 0.3 kN to 15 kN.

The stamping time, in particular in the case of up-and-down stamping, is preferably selected from the range of from 0.3 s to 2.5 s, preferably from 0.5 s to 2.0 s, particularly preferably from 1.0 s to 1.5 s, wherein the stamping time is preferably adapted to the layer thickness of the carrier.

Further, it is also possible for the stamping pressure, in particular in the case of roll stamping, preferably to be selected from a range of from 10 kg/cm² to 50 kg/cm², preferably from 15 kg/cm² to 30 kg/cm², particularly preferably 20 kg/cm² to 25 kg/cm².

To set the stamping pressure for a roll stamping, a stamping wheel or a stamping roller is moved down vertically onto a substrate, for example the transfer ply. Then the contact area formed there, which results from the squeezing of the coating, for example of the silicone rubber, of the stamping wheel or the stamping roller, is measured. The contact area is influenced by the hardness of the coating and by the stamping pressure applied. Theoretically, the contact area in the case of very hard materials corresponds merely to a line contact between stamping wheel or stamping roller and substrate. The resulting contact area is then called “print image”. In the case of a stamping wheel or a stamping roller with a Shore A of 80, a preferred print image is a strip 20 mm to 25 mm wide. In the case of a Shore A of 60, a preferred print image is a strip 30 mm to 55 mm wide. Depending on the width of the stamping wheel or the stamping roller and the resulting surface area, a force with which the stamping wheel or the stamping roller is pressed onto the substrate can then be specified. The stamping pressure used can thus expediently be specified, in particular in the case of roll stamping, in dependence on the contact area. If the contact area and the stamping pressure are known, they can also be converted into a stamping pressure in Newtons.

If, for example, the stamping wheel or the stamping roller is 100 mm wide and the contact area is 25 mm wide, a surface area of 100 mm×25 mm=25 cm² results. With a sought value of 25 kg/cm² and a contact area of 25 cm², a stamping pressure of 625 N results from this. The width of the stamping wheel is measured on its outermost circumference.

For example, a good result is achieved in the case of a stamping process, in particular in the case of up-and-down stamping, with the combination of a stamping temperature of 190° C., a stamping time of 1.5 s and a stamping pressure of 15 kN.

In the case of a stamping process, in particular by means of roll stamping, a good result is achieved for example with the combination of a stamping temperature of 185° C., a stamping speed of 2 m/min, a stamping pressure of from 20 kg/cm² to 25 kg/cm² and using a stamping roller with a hardness of 80 Shore A.

The master structure has in particular a structure depth selected from a range of from 0.1 μm to 15 μm, preferably from 0.1 μm to 10 μm, particularly preferably from 0.1 μm to 5 μm. In particular, the master structure has an average structure spacing selected from the range of from 0.05 μm to 1000 μm, preferably from 0.1 μm to 100 μm, particularly preferably from 0.1 μm to 50 μm.

The complementary relief structure can have in particular a smaller structure depth than the master structure. In particular, the complementary relief structure has a structure depth which preferably corresponds to 20% to 99% of the structure depth of the master structure, particularly preferably corresponds to 40% to 95% of the structure depth of the master structure.

By structure depth is meant the distance of the maxima of the elevation of the master structure from the minima of the depressions, in a perpendicular view onto the plane which is spanned by the carrier having the master structure.

By structure spacing is meant the spacing between two neighboring minima of the depressions when viewed perpendicular to the plane which is spanned by the carrier having the master structure.

The master structure or the complementary relief structure can have, alone or in combination, a regular one-dimensional grating, a regular two-dimensional grating, a random structure component or a pseudo-random structure component. In particular, the complementary relief structure can have optical and/or functional effects.

Random relief structure can be generated for example with carriers with an introduced surface roughness or introduced particles, for example with a matte-finished or brush-finished carrier or with a carrier comprising a master structure layer into which particles have been incorporated. In particular, a rather undefined and rounded profile shape is generated hereby.

By pseudo-random relief structure is meant a relief structure which appears as a random relief structure in the case of a local view, but is preferably reproducible in a targeted manner at regular spacings and is thus not recognizable as a random structure.

A preferred one-dimensional or two-dimensional grating is a non-random relief structure which preferably has exact and geometrically formed profile shapes such as rectangular profiles, sinusoidal profiles, sawtooth profiles, hemispherical profiles or blazed structures. Furthermore, a one-dimensional or two-dimensional grating can have binary profiles or profiles with profile depth staggered in the manner of a staircase or with constant profile depth.

It is advantageous if the master structure has been designed such that the complementary relief structure comprises a microstructure, in particular a microstructure the dimensions of which lie below the resolution limit of the unaided human eye. The resolution limit of the unaided human eye preferably lies at structures with dimensions of at least 300 μm.

Further, the master structure can be designed such that the complementary relief structure comprises a macrostructure, in particular a macrostructure the dimensions of which lie above the resolution limit of the unaided human eye.

Further, the master structure can be designed such that the complementary relief structure be formed as a microstructure the dimensions of which lie below the resolution limit of the unaided human eye and additionally as a macrostructure which is visible to the unaided human eye. A macrostructure can be present next to a microstructure and/or can have been superimposed by a microstructure.

A microstructure can advantageously have an optical effect which simulates the presence of a macrostructure.

The master structure can be designed such that the complementary relief structure is formed as a matte structure, as a diffractive structure and/or as a refractive structure and/or as a macrostructure. Further, several of the above-named structures can also be present next to each other and/or can have been superimposed with each other.

Diffractive structures are structures which form optical effects based on light diffraction, for example diffraction gratings or holograms. These can be conventional 2D/3D or 3D holograms, which allow the representation of three-dimensional information on the basis of a surface structure. Viewed locally, the profile of a holographically generated hologram, such as for example a Fourier hologram, can be viewed as approximately periodic, wherein typical numbers of lines lie in the range of from 300 lines/mm to 3000 lines/mm and typical structure depths lie in the range of from 50 nm to 1000 nm. For achromatic effects, however, very coarse grating structures with numbers of lines in the range of from 10 lines/mm to 300 lines/mm and structure depths in the range of from 0.5 μm to 10 μm can also be used.

A computer-generated hologram, such as for example the so-called kinoform, can create the impression of a stochastic surface relief and have an asymmetric diffraction effect. A typical structure depth is half or a multiple of the wavelength of the incident light and is geared to whether the kinoform is to deploy its effect in transmission or reflection.

The matte structure is a diffractive structure with stochastic progression, with the result that incident light is dispersed in a random manner. Matte structures have fine relief structure elements on the microscopic scale, which determine the scattering power and can be described with statistical characteristic values. The average spacing of the relief structure elements in the x and/or y direction of the plane spanned by the transfer film, the roughness average Ra, and the correlation length Ic are examples of these characteristic values. Preferred matte structures have an average spacing in the range of from 300 nm to 5000 nm, a roughness average, Ra, in the range of from 20 nm to 2000 nm, preferably from 50 nm to 500 nm. The correlation length, Ic, preferably lies in the range of from 200 nm to 50,000 nm, preferably from 500 nm to 10,000 nm.

Refractive structures are structures which form optical effects based on light refraction and/or light reflection, for example microlenses or micromirrors. Such microlenses or micromirrors are in particular not used individually, but preferably arranged next to each other in a regular or also pseudorandom grid or pixel array.

Optically variable effects on the basis of the previously named structures can be realized for example by varying one or more structure parameters, for example by varying the grating period, the average structure spacing, the angle of inclination of the micromirrors, the structure depth and/or the azimuthal angle.

Preferably, the carrier comprising the master structure is used for a small number of stampings in the same region of surface of the carrier, in particular selected from a range of from once to 20 times, preferably from once to 10 times. If a carrier are used for too large a number of stampings, accumulated contamination has a negative effect on the stamping.

The advantage of the use of a carrier, wherein it is replaced regularly, is that contamination of the master structure, which accumulates during the stamping, does not build up on the carrier, but rather that after a defined maximum number of stampings in the same region of surface of the carrier a new region of surface of the carrier with unused structure is immediately available. The new region of surface is then cleaner for example and the master structure has the envisaged structure depths. A consistently high-quality stamping is thus obtained hereby.

When a stamping tool without carrier is used, it is to be borne in mind that contamination can also accumulate over time or the surface, for example the surface coating of elastomer, cures over time. The quality of the relief structure introduced into the protective varnish layer can thus also decline here and a replacement of the stamping tool can be necessary, wherein this is more cost-intensive than replacing a carrier.

In particular, it is advantageous that at least 20%, preferably at least 40%, further preferably at least 50%, still further preferably at least 70%, of the relief shape or surface structure of the master structure, in particular of the structure depth of the master structure, is and/or has been molded into the protective varnish layer and/or print layer. In the finished article, the envisaged relief structure hereby has the desired optical properties.

It is possible to provide and/or to obtain a base body which has a surface which faces or will face the transfer film and/or optionally the substrate and wherein at least one bevel, preferably a chamfer, has been arranged on this surface. The at least one bevel, preferably chamfer, has been arranged on at least one outer edge of the base body.

The bevel preferably has an angle relative to the surface normal of the plane formed by the surface of the base body, selected from the range of from 15° to 75°, further preferably from 25° to 65°. The base body preferably has a bevel, preferably chamfer, on opposite edges.

When the transfer ply and/or print layer are arranged on the base body, the transfer ply and/or the print layer preferably adopts the contour of the base body. It is possible for the first region to be and/or to have been formed on the bevel and on the plane formed by the surface of the base body, in particular to be and/or to have been formed uninterrupted.

It is possible for the stamping tool, in particular stamping wheel, to have been made height-adjustable. The height adjustment of the stamping tool can be performed by means of one or more servo motors or via pneumatic control. This provides the advantage that the same stamping pressure is exerted over the entire surface. It is hereby possible to form a uniformly designed and interrupted first region.

The carrier comprising the master structure is advantageously supplied in particular in rolls and is thus able to be transported further as a carrier web. A particularly quick change of the region of surface of the carrier used for the stamping is possible here. It is further also possible to provide and to use a carrier comprising the master structure in the form of sheet material or as a board. This can also be easily replaced and also individualized as needed. The carrier preferably consists of or comprises polymer, for example PET. The carrier preferably has a layer thickness selected from a range of from 5 μm to 500 μm, preferably from 20 μm to 50 μm.

Alternatively, the carrier can consist of or comprise metal, for example brass, copper, steel or titanium.

The master structure was preferably introduced into the carrier during the production of the carrier, in particular during an extrusion of the carrier. This provides the advantage that the structure is resistant to the temperatures in the stamping step.

For example, step e) can have at least one or more of the following substeps:
arranging and aligning the transfer film, preferably transfer ply, and the base body according to the stamping tool or the carrier;
heating the stamping tool to stamping temperature
contacting the master structure of the stamping tool or of the carrier with the transfer ply, in particular the protective varnish layer, in particular in the at least one first region;
moving or rotating the stamping tool or the carrier.

Step e) is preferably carried out after steps A1) and/or A2) and/or after A3). Step e) is preferably carried out after step d) and in particular before step f). Step e) can also be carried out multiple times, in particular with differing or identical stamping tools or carriers comprising identical or different master structure.

In particular, the at least one first region is formed in step e) such that the transfer ply has a relief structure in the at least one first region, wherein the relief structure is preferably complementary to the master structure of the stamping tool and/or of the carrier used. The at least second region preferably has no structure and is perceived as smooth and flat. In particular, the at least one first region differs optically or functionally from the at least one second region, in particular by its gloss level or transmittance.

The at least one first region is preferably formed in the protective varnish layer and/or print layer only in regions when viewed perpendicular to a plane spanned by the protective varnish layer and/or print layer. The protective varnish layer and/or print layer preferably has the at least one first region only in regions.

The at least one first region preferably consists of one or more regions that are contiguous and/or separated from each other, in particular when viewed perpendicular to the plane spanned by the protective varnish layer and/or print layer. For example, the at least one first region can completely surround the at least one second region and/or the at least one first region can be completely surrounded by the at least one second region completely. The at least one first region and the at least one second region have been arranged next to each other and do not overlap, in particular when viewed perpendicular to the plane spanned by the protective varnish layer and/or print layer.

In particular, the design or shape of the at least one first region is selected individually or in combination from: motif, letter, numeral, symbol, geometric figure, visually recognizable design element, pattern, logo, codes and strip conductor.

In particular, the at least one first region is formed in the protective varnish layer and/or in the print layer register-accurately relative to a layer or an element, preferably decorative element and/or functional element, of the transfer ply and/or of the base body. For this purpose, for example, the protective varnish layer and/or the print layer can be masked such that the relief structure is formed only in the unmasked at least one first region.

By register-accurate is meant a positional accuracy of two or more plies, elements, regions and/or layers relative to each other. The register accuracy is to range within a predefined tolerance, which is to be as small as possible. At the same time, the register accuracy of several plies, elements, regions and/or layers relative to each other is an important feature in order to increase the process reliability and/or the product quality, but also the protection against forgery. The positionally accurate positioning can be effected in particular by means of sensorily, preferably optically, detectable register marks. These register marks can either represent special separate plies, elements, regions and/or layers or themselves be part of the plies, elements, regions and/or layers to be positioned.

Further, it is possible for the protective varnish layer of the transfer film and/or of the print layer and/or of the article to have a transmittance of at least 45%, preferably of at least 70%, for the wavelength range perceptible by the human eye, preferably for the range from 400 nm to 700 nm, in the at least one first region and/or in the at least one second region. For example, displays or light sources can hereby be perceived in the at least one first region and/or in the at least one second region. This provides the advantage that a produced article can be backlit.

The at least one first region of the print layer and/or of the insert and/or of the transfer film, in particular of the protective varnish layer or of the article, can have a gloss value selected from a range of from 1 GU to 59 GU, preferably from 5 GU to 30 GU, or be designed in such a way.

The at least one second region of the print layer and/or of the insert and/or of the transfer film, which preferably has no relief structure, in particular of the protective varnish layer or of the article, can have a gloss value selected from a range of from 31 GU to 98 GU, preferably from 60 GU to 90 GU.

Gloss values can thus advantageously be set such that the at least one first region and the at least one second region differ from each other in an optically perceptible manner. In particular, very matte surfaces are thus also possible because of corresponding structures, which are not possible through other varnishes, in particular known structured protective varnishes.

The gloss values are measured at a measuring angle of 60° with the “micro-gloss” meter from Byk-Gardener GmbH, Geretsried. During the gloss measurement, a precisely defined directed light beam is directed, in particular at a 60° angle, for example onto a varnish surface such as the protective varnish layer of the transfer film and/or of the article and a reflectometer lying opposite measures how much light is reflected at a 60° angle (grazing angle). The gloss is advantageously calibrated to 100 GU (gloss units) (=100%) using a standard. The highest achievable gloss value are thus preferably 100 GU. The gloss value is advantageously given in percent (%). It is therefore expedient if the unit of the gloss value is percent (%) in this case. The measured gloss value is therefore preferably a value from a range of from 0% to 100%. Thus, the gloss units are in particular percentage values and the gloss units represent in particular percentage values.

It is possible for the method of producing the article expediently further to comprise the optional the following step, which is in particular carried out after step e) and before step g):
f) curing the protective varnish layer and/or print layer not yet completely cured at least in regions, wherein the protective varnish layer and/or print layer cures completely at least in regions.

All curable components of the article are preferably completely cured in step f). Thus, the protective varnish has a high chemical and mechanical resistance in all regions after step f).

In particular, in step f) the complete curing of the protective varnish layer and/or print layer is carried out by means of high-energy electromagnetic radiation, in particular UV irradiation, and/or by means of high-energy particle radiation, in particular electron beam radiation, and/or is carried out by means of curing, preferably at a temperature in a range of from 25° C. to 180° C., of the protective varnish layer and/or print layer.

The irradiation is preferably carried out by means of high-energy electromagnetic radiation and/or high-energy particle radiation. The electromagnetic radiation is preferably UV radiation, in particular from a wavelength range of from 100 nm to 390 nm, preferably from 200 nm to 380 nm, particularly preferably from 200 nm to 300 nm. The particle radiation is preferably electron beam radiation.

For the complete curing in step f) the protective varnish layer and/or print layer is irradiated with an irradiance selected from the range of from 500 mW/cm² to 700 mW/cm². The UV dose is preferably selected from the range of from 2000 mJ/cm² to 3500 mJ/cm². The irradiation is preferably effected over a period selected from the range of from 1 s to 10 s, preferably from 2 s to 6 s.

Due to the possibility of carrying out step f) and/or due to the not yet completely cured protective varnish layer and/or print layer, a range of advantages result. The not yet completely cured transfer film, preferably transfer ply, is hereby in particular more easily deformable than a transfer film, preferably transfer ply, with completely cured layers. Even in the case of the generation of curvatures it is thereby guaranteed in particular that corresponding layers can stretch without the occurrence of cracking and other adverse effects. If a deformation in particular of the transfer film, preferably transfer ply, for example in an injection mold or during a deep drawing, has been effected, the protective varnish layer and/or print layer can be cured subsequently in order to achieve their ultimate hardness and resistance.

The article produced using the method, which comprises the transfer ply, in particular the protective varnish layer, and/or print layer and the base body, and optionally the substrate, is obtained in step g). Thus, step g) is in particular the last step of the method according to the invention and is preferably carried out after step e) or.

The article preferably has the protective varnish layer and/or print layer as an outermost surface. Preferably, no further layers have been applied to the protective varnish layer and/or print layer, wherein a high resistance of the outermost surface, in particular compared with the base body and/or optionally substrate, is advantageously guaranteed.

The article preferably comprises at least one decorative layer containing at least one decorative element, in particular in the transfer ply of the transfer film and/or of the insert, and/or at least one functional layer containing at least one functional element, in particular in the transfer ply of the transfer film and/or of the insert.

An article produced according to the method according to the invention can be used in a plurality of fields. The produced article can be used for example, alone or in combination, as a display window, touch panel, panel, cover plate, cladding, cover, functional element, electronic article and housing part or outer part, in particular of white goods and/or of domestic appliances and/or of automotive interior regions and/or of automotive exterior regions.

It is further possible for the method steps to be carried out once or multiple times. In particular, method steps can be repeated. A preferred method has at least the following steps a), e) and g), optionally a), e), f) and g), wherein further steps can in particular have been inserted between these steps.

For an IMD method, the method has in particular at least the following steps in the order a1), b1), c1), d), e), g), optionally a1), b1), c1), d), e), f), g).

For an insert-molding method, the method has in particular at least the following steps in the order a2), b2, c2), e), g), optionally a2), b2, c2), e), f), g). Alternatively, the method, for an insert-molding method, has in particular at least the following steps in the order a1), h), d), b1), c1), e), g), optionally a1), h), d), b1), c1), e), f), g). It is possible for an insert-molding method to have at least the steps in the order a1), h), d), i), j), b1), c1), e), g), optionally a1), h), d), i), j), b1), c1), e), f), g).

For an injection-molding method with downstream hot-stamping methods, the method has in particular at least the following steps in the order a3), k3), d), e), g), optionally a3), k3), d), e), f), g).

In particular if the method of producing an article is an IMD method, it can comprise at least the following steps once or multiple times:
a1) providing a transfer film, wherein the transfer film has a carrier ply and a transfer ply, wherein the carrier ply can be peeled off the transfer ply, wherein the carrier ply comprises a carrier layer, wherein the transfer ply comprises a protective varnish layer, wherein the protective varnish layer has not yet been completely cured or is thermoplastic at least in regions,
and wherein the protective varnish layer has been arranged such that it is in contact with the carrier ply;
b1) arranging the transfer film, in particular the transfer ply, in an injection mold;
c1) back-injection molding the transfer film, in particular the transfer ply, with a plastic material, wherein the plastic material forms a base body;
d) detaching the carrier ply from the transfer ply;
e) forming at least one first region and at least one second region in the protective varnish layer by means of stamping, wherein the at least one first region has a relief structure;
f) optionally curing the protective varnish layer not yet completely cured at least in regions, wherein the protective varnish layer cures completely at least in regions;
g) obtaining an article, wherein the article comprises a base body and a protective varnish layer, which has been cured or is thermoplastic at least in regions, wherein the protective varnish layer has at least one first region and at least one second region, wherein a relief structure has been arranged in the at least one first region.

In particular if the method of producing an article is an insert-molding method, it can comprise at least the following steps once or multiple times:
a2) providing an insert, wherein the insert has a substrate and, arranged on the substrate, a transfer ply and/or a print layer, wherein the transfer ply comprises a protective varnish layer, wherein the protective varnish layer and/or the print layer has not yet been completely cured or is thermoplastic at least in regions;
b2) arranging the insert in an injection mold;
c2) back-injection molding the insert with a plastic material, wherein the plastic material forms a base body;
e) forming at least one first region and at least one second region in the protective varnish layer and/or in the print layer by means of stamping, wherein the at least one first region has a relief structure;
f) optionally curing the protective varnish layer not yet completely cured at least in regions, wherein the protective varnish layer and/or the print layer cures completely at least in regions;
g) obtaining an article, wherein the article comprises a base body and a protective varnish layer and/or a print layer, which has been cured or is thermoplastic at least in regions, wherein the protective varnish layer and/or a print layer has at least one first region and at least one second region, wherein a relief structure has been arranged in the at least one first region.

In particular if the method of producing an article is an injection-molding method with subsequent hot stamping, it can comprise at least the following steps once or multiple times:
a3) providing a transfer film, wherein the transfer film has a carrier ply and a transfer ply, wherein the carrier ply can be peeled off the transfer ply, wherein the carrier ply comprises a carrier layer, wherein the transfer ply comprises a protective varnish layer and wherein the protective varnish layer has been arranged such that it is in contact with the carrier ply, wherein the protective varnish layer has not yet been completely cured or is thermoplastic at least in regions and providing, separately from the transfer film, a base body, which is in particular produced by means of injection molding;
k3) arranging the transfer film, in particular the transfer ply, on a surface of the base body and hot stamping the transfer film onto the surface of the base body;
d) detaching the carrier ply from the transfer ply;
e) forming at least one first region and at least one second region in the protective varnish layer by means of stamping, wherein the at least one first region has a relief structure;
f) optionally curing the protective varnish layer not yet completely cured at least in regions, wherein the protective varnish layer cures completely at least in regions;
g) obtaining an article, wherein the article comprises a base body and a protective varnish layer, which has been cured or is thermoplastic at least in regions, wherein the protective varnish layer has at least one first region and at least one second region, wherein a relief structure has been arranged in the at least one first region.

Of course, the above-mentioned characteristics can also be applied in an equivalent way in a method, or mentioned method features can also be applied in the product.

In the following, the invention is explained by way of example with reference to several embodiment examples with the aid of the accompanying drawings. The embodiment examples shown are therefore not to be understood as limitative.

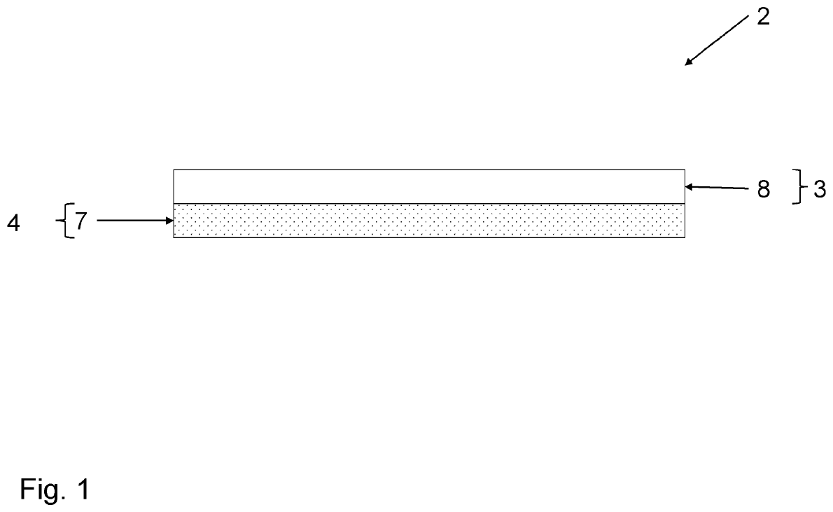

FIG. 1 shows a schematic representation of a transfer film suitable for the method.

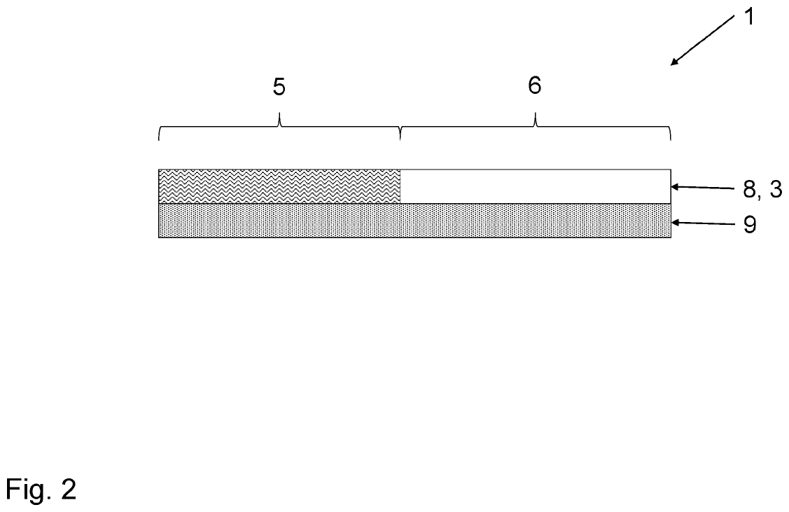

FIG. 2 shows a schematic side view of an article obtained using the method.

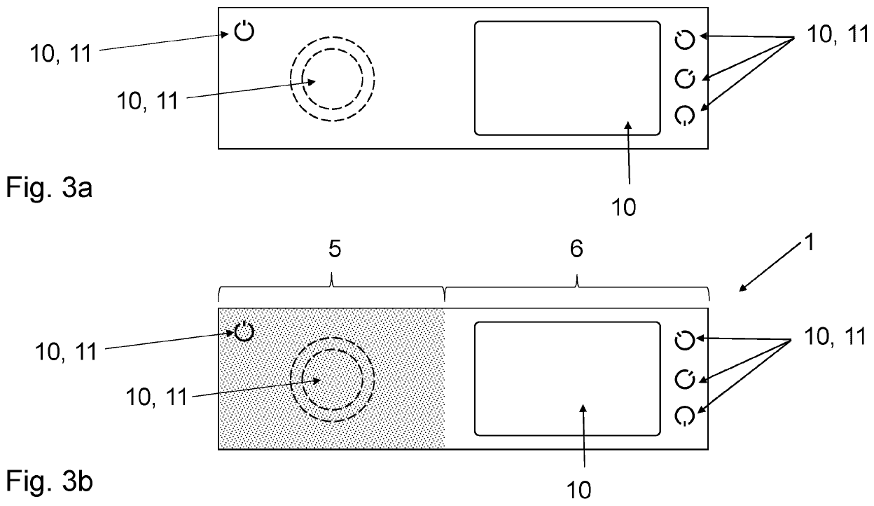

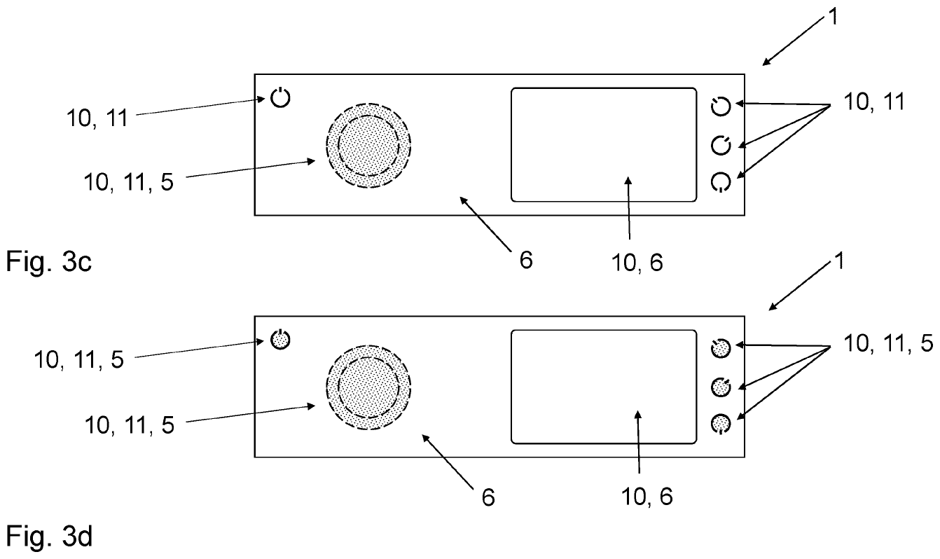

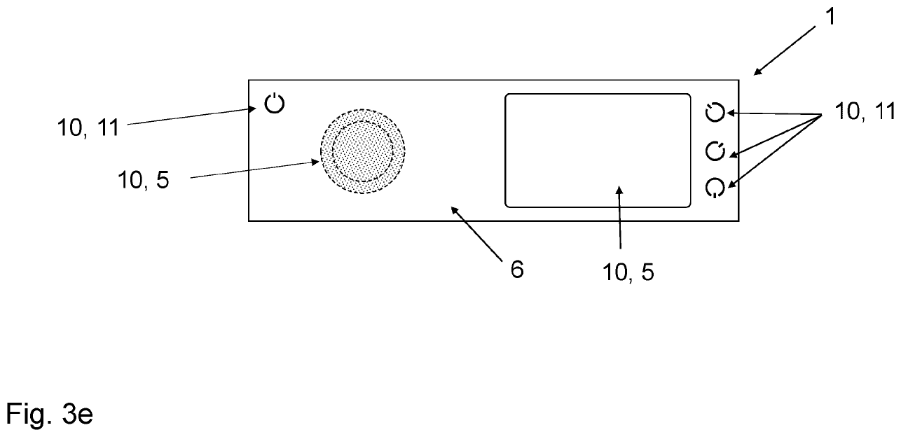

FIG. 3a shows a schematic top view of an intermediate product obtained using the method.

FIGS. 3b to 3e show schematic top views of an article obtained using the method.

FIG. 1 shows a schematic transfer film 2 which is suitable for the method of the invention and can be provided in step a), preferably in step a1) and/or step a3).

This transfer film 2 has in particular a transfer ply 3 and a carrier ply 4, wherein the transfer ply 3 is detachable from the carrier ply 4. The transfer ply 3 can have been constructed single-layered or multi-layered. In this example the transfer ply 3 shown in FIG. 1 is single-layered and has a protective varnish layer 8, which preferably has not yet been completely cured or consists of a thermoplastic at least in regions.

In step a) it is possible for the transfer film 2 to be provided in rolls. It is further possible the transfer film 2 to be provided as a hot-stamping film or as an IMD film. The article 1 is preferably produced in an IMD method or an insert-molding method.

Alternatively, according to step a2) it is possible already to provide an insert. In a further alternative according to step a3) it is possible for a base body 9 to be provided separately. It is possible for a provided insert to have a multi-layered transfer ply and/or a multi-layered print layer. The print layer has preferably been arranged on the insert partially or over the whole surface. The print layer has been formed in particular as a screen print layer, as a gravure print layer, as an inkjet print layer or as a combination thereof. The insert preferably has a gravure print layer and a screen print layer. It is possible for the layers of the print layer to overlap at least partially. It is possible for the insert to have a transfer ply, on which one or more print layers have been partially printed.

The transfer ply 3 of the provided transfer film 2 preferably has a layer thickness selected from a range of from 0.1 μm to 100 μm, preferably from 0.5 μm to 75 μm, further preferably from 1 μm to 50 μm.

The protective varnish layer 8 protects the obtained article 1 in particular from external influences such as UV radiation, mechanical influences, for example scratches, or chemical influences, for example creams or solvents. The protective varnish layer 8 thus has in particular a high resistance to mechanical and chemical strains, in particular compared with the layers and/or base body 9 lying underneath it.

The protective varnish layer 8 preferably has a layer thickness selected from a range of from 1 μm to 15 μm, preferably from 2 μm to 8 μm, further preferably from 2 μm to 5 μm.

Further, the protective varnish layer 8 has in particular a transmittance of at least 70%, preferably of at least 85%, for the wavelength range perceptible by the human eye, preferably for the range from 400 nm to 700 nm.

In particular, the protective varnish layer 8 has not yet been completely cured at least in regions. Preferably, the protective varnish layer 8 has been precured chemically and/or by means of irradiation, preferably UV irradiation, at least in regions and/or is still completely curable by means of irradiation, preferably UV irradiation, at least in regions. For this purpose, the protective varnish layer 8 has at least one UV-crosslinkable polymer. A UV-crosslinkable polymer within the meaning of the invention preferably has at least one, preferably two or more, ethylenically unsaturated double bond(s).

The protective varnish layer 8 not yet cured in regions has preferably been produced on the basis, alone or in combination, of at least one UV-crosslinkable or at least one chemically crosslinkable polymer. Further, the protective varnish layer 8 can have been produced from thermoplastic polymer.

In a preferred embodiment, the protective varnish layer 8 has been formed as a print layer, in particular as a screen print layer 8, as a gravure print layer, as an inkjet print layer or as a combination thereof. Here, the protective varnish layer 8 preferably has a transmittance of at most 30%, preferably of at most 15%, for the wavelength range perceptible by the human eye, preferably for the range from 400 nm to 700 nm.

The protective varnish layer has preferably been arranged in the transfer ply 3 over the whole surface. Alternatively, in an embodiment not shown here, it is possible for the protective varnish layer 8 to have been arranged in the transfer ply 3 partially. It is possible for the protective varnish layer 8 to have been formed multi-layered, in particular wherein the layers of the protective varnish layer 8 overlap at least partially.

In a further embodiment not shown here, it is possible for a print layer to have been and/or to be arranged on the protective varnish layer 8, in particular wherein the print layer has not yet been completely cured at least in regions. This print layer has been and/or is arranged on the protective varnish layer preferably partially or over the whole surface. Further, this print layer, in particular further print layer, has been formed in particular as a screen print layer, as a gravure print layer, as an inkjet print layer or as a combination thereof, preferably as a screen print layer.

The transfer ply 3 has in particular at least one decorative layer containing at least one decorative element 11, preferably on the side of the protective varnish layer 8 facing away from the carrier ply 4.

Further, the at least one decorative element 11 containing by the at least one decorative layer is preferably selected from the group which consists of transparent and/or colored varnish layers, in particular comprising one or more dyes and/or pigments, replication layers with a molded optically active surface structure, reflective layers, in particular opaque reflective layers, transparent reflective layers, metallic reflective layers or dielectric reflective layers, optically variable layers, optically active layers, interference multilayer systems, volume hologram layers, liquid crystal layers, in particular cholesteric liquid crystal layers, and combinations thereof.

Alternatively or additionally, it is possible for the transfer ply 3 to have at least one functional layer containing at least one functional element 10 on the side of the protective varnish layer facing away from the carrier ply. It is possible here for at least one functional layer to have been arranged overlapping and/or neighboring at least one decorative layer. It is also possible for at least one functional layer to have been arranged between at least two decorative layers or for at least one decorative layer to have been arranged on a side of a functional layer facing and/or facing away from the protective varnish layer 8.

The at least one functional element 10 is in particular selected from the group which consists of at least one electronic element, in particular a strip conductor, contact element, LED, sensor, in particular touch sensor, temperature sensor, pressure sensor, antenna, in particular RFID element, memory, control element, display, processor, capacitor, resistor, microfluidic element and combinations thereof.

For example, the functional layer can have been designed, alone or in combination, as electrically conductive layers, antenna layers, electrode layers, magnetic layers, magnetic memory layers or barrier layers.

Preferably, the at least one decorative element 11 has been arranged in at least one decorative layer and/or the at least one functional element 10 has been arranged in at least one functional layer, which comprise, in each case independently of one another, a UV-crosslinked varnish or a chemically crosslinked varnish or a thermoplastically deformable layer and which are, in each case independently of one another, unpigmented or pigmented or dyed.

It is also conceivable that the protective varnish layer 8 preferably has at least one decorative element 11 and/or a functional element 10 or for example none of these at least partially.

An adhesion-promoter layer has preferably been arranged between the protective varnish layer 8 and the at least one decorative element 11 and/or the at least one functional element 10. It is possible here for the adhesion-promoter layer to comprise or consist of at least one acrylic resin. It is further possible for the adhesion-promoter layer preferably to have a layer thickness in a range of from 0.1 μm to 10 μm.

It is also possible for the transfer ply 3 to have at least one varnish layer, preferably with a layer thickness selected from a range of from 0.5 μm to 10 μm, which forms a surface of the transfer ply 3 facing away from the carrier ply 4. This varnish layer is preferably used for joining to the base body 9 or the plastic material. The at least one varnish layer preferably comprises or consists of at least one adhesive, which is selected from the group which consists of physically curing adhesives, chemically curing adhesives, pressure-sensitive adhesives or mixtures thereof. It is further possible for the at least one varnish layer to be a primer layer and/or for a primer layer to have been arranged in place of the at least one varnish layer and/or for a primer layer to have been arranged on the side of the at least one varnish layer facing away from the protective varnish layer 8, in particular wherein the primer layer comprises or consists of PVC copolymers and PMMA.

Further, the transfer ply 3 can have at least one or more of the following layers, in each case selected individually or in combination from: at least one colored varnish layer, at least one metal layer, at least one oxide layer, at least one barrier layer, at least one receiving layer, at least one second protective varnish layer, at least one replication layer, at least one laser protective varnish layer. The layers can have been arranged in the transfer ply 3 in each case over the whole surface or in each case partially.

The carrier layer 7 of the transfer film 2 is provided with a carrier ply 4, which, preferably alone or in combination, consists of or comprises polyethylene terephthalate (PET), glycol-modified polyethylene terephthalate (PETG), polypropylene (PP), polycarbonate (PC), polyimide (PI) or polyamide (PA), and/or blends or copolymers thereof. The carrier ply, preferably the carrier layer, preferably has a layer thickness selected from a range of from 10 μm to 100 μm, preferably from 10 μm to 50 μm.

It is possible for the carrier ply 4 to have at least one detachment layer, which has preferably been arranged between the carrier layer 7 and the protective varnish layer 8. The layer thickness of the detachment layer lies in particular in a range of from 0.1 nm to 100 nm. The detachment layer preferably comprises or consists of at least one wax, for example a polyethylene wax. The detachment layer preferably has a melting temperature in a range of from 80° C. to 100° C. The carrier ply 4 has preferably been arranged on the protective varnish layer 8 with an adhesive force in a range of from 2 cN to 50 cN, preferably in a range of from 5 cN to 35 cN, or this force needs to be overcome when the carrier ply 4 is peeled off.

Once the transfer film 2 has been provided in step a), preferably step a1), the next step in the method according to the invention is effected, for example step b), by arranging transfer ply 3 in an injection mold.

However, it is also conceivable that the transfer film 2 is arranged on a substrate, is shaped, preferably pre-deformed and/or deep-drawn and/or trimmed before step b) and in particular before step d). Here, it is advantageous in particular if the protective varnish layer 8 has not yet been cured at least in regions, as it then has a much greater stretchability.

In other words, it is possible for the method further to comprise at least one of the following steps h), i) and j):
h) arranging the transfer film 2 on a substrate;
i) shaping the transfer film 2 and/or the substrate into a desired shape by application of heat and pressure; and
j) trimming the transfer film 2 and/or the substrate along a defined contour line.

In particular, it is possible for steps h), i) and j) to be carried out after step a), preferably step a1). Step h) is preferably carried out after step d). Steps i) and j) are preferably carried out after step d) and preferably before step b). It may also be appropriate to carry out steps i) and j) before step d), in particular if only a slight shaping is carried out in step i).

In particular, the arranging of the transfer film 2 on a substrate is effected by means of stamping, in particular hot stamping or cold stamping. The arranging of the transfer film 2 is preferably effected by application of heat and/or pressure and/or irradiation by means of UV radiation.

In particular, the substrate is selected, alone or in combination, from polycarbonate (PC), polycarbonate/acrylonitrile butadiene styrene (PC/ABS), polypropylene (PP), thermoplastic polyurethane (TPU), polymethyl methacrylate (PMMA), or blends and/or coextrudates thereof.

In particular, the shaping can be effected, alone or in combination, by deep drawing or vacuum forming. The shaping is preferably effected by application of heat and/or pressure. In particular, the trimming can be effected, alone or in combination, by means of waterjet cutting, lasers or punching.

The transfer ply 3 is arranged in an injection mold in step b) and back-injection molded with a plastic material in step c). Step b) is preferably carried out after step a) or after step j) and in particular before step c). Step c) is preferably carried out before step d) and/or after step b). In particular, step c) can be carried out once or multiple times, in particular wherein identical or different plastic materials are used.

The injection mold expediently has the shape of the surface of the article 1 and/or predefines it. It is possible to obtain an article 1 which is a rigid body. It is preferably possible for the surface of the article 1, in particular with the protective varnish layer, to be curved and/or bent.

During the back-injection molding of the transfer ply 3, in particular in step c), the transfer ply 3 or optionally the substrate is preferably covered with the plastic material at least in regions on at least one surface of the transfer ply 3 of the transfer film 2 facing away from the carrier ply 4. For this purpose, the transfer film 2 is arranged in the injection mold and the injection mold is filled with at least the plastic material. It is further possible for the injection mold to be formed of two mold halves, in particular which have been opened before step b) and are closed before step c), preferably wherein the injection mold is formed.

The base body 9 is formed of the plastic material and comprises the plastic material. The plastic material preferably comprises thermoplastic plastic, selected individually or in combination from polycarbonate (PC), polyethylene therephthalate (PET), polypropylene (PP), polymethyl methacrylate (PMMA), polyethylene naphthalate (PEN), polyamide (PA), acrylonitrile butadiene styrene copolymer (ABS), ABS/PC, PC/ABS and thermoplastic polyurethane (TPU). The base body 9 can be formed single-layered or multi-layered.

It is further possible for the base body 9 to have a transmittance of at least 45%, preferably of at least 70%, for the wavelength range perceptible by the human eye, preferably for the range from 400 nm to 700 nm. For example, displays or light sources can hereby be perceived through the base body 9.

After the plastic material has cooled or after the base body 9 has been formed, the base body 9 and the transfer film 2 are advantageously removed from the mold. In particular, the transfer film 2 and/or optionally the substrate has been joined to the base body 9 after step c). The transfer ply and/or the substrate can no longer be removed from the base body in a destruction-free manner.

In an alternative embodiment, a step k3) is carried out instead of step c). Here, the transfer film 2, in particular the transfer ply 3, is arranged on a surface of the base body 9 provided in step a3). Further, the transfer film 2, preferably the transfer ply 3, is joined to the surface of the base body 9 by means of hot stamping. The transfer ply 3 can preferably no longer be removed from the base body 9 in a destruction-free manner. It is further possible for the transfer ply 3 to be and/or to have been arranged on the base body 9 partially or over the whole surface.

The carrier ply is detached from the transfer ply in step d). Step d) is preferably carried out before step e). In particular, step d) can be carried out before step f), and before step g). Further, step d) is preferably carried out after step c). It is possible for step d) to be carried out after step k3).

A possibly present detachment layer can remain on the carrier ply 4 or remain on the transfer ply 3 when the carrier ply 4 is removed. Further, it is also possible for the detachment layer to break up, with the result that after the carrier ply 4 has been removed residues of the detachment layer are arranged on the carrier ply 4 and on the transfer ply 3.

It is further possible for the back-injection molding of the transfer ply 3 in step c) and the detachment of the carrier ply 4 in step d) to be carried out with a spatial separation. Here, it is possible for the transfer ply 3 joined to the base body 9 to be stored temporarily and/or transported. It is then possible, in particular at a different production location, to individualize the article 1 by means of forming the at least one first region 5 and the at least one second region 6.

At least one first region 5 and at least one second region 6 are now formed in the protective varnish layer 8 and/or print layer in step e). This is effected by means of a stamping method, for example hot stamping, in particular roll stamping or up-and-down stamping, preferably by contacting the protective varnish layer 8 and/or print layer with a stamping tool 13. The stamping tool 13 can have a master structure on the surface which is contacted with the protective varnish layer 8 and/or print layer.

The master structure on the surface of the stamping tool 13 can have been introduced for example by laser machining and/or by etching methods and/or by means of other known surface treatment methods.

In a further embodiment variant it is possible for a carrier comprising a master structure to be arranged between a stamping tool 13 and the transfer ply 3 and/or between a stamping tool 13 and the print layer at least in regions. In other words, it is possible for the stamping tool 13 to be able to have a carrier comprising a master structure at least in regions. In this case, the stamping tool 13 preferably has no master structure and/or is smooth and preferably predefines only with a contour of the stamping surface as outer contour and possibly predefines the stamping surface with one or more recesses inside the outer contour as inner contour.

Alternatively, the stamping tool 13 can have an additional master structure in addition to the master structure of the carrier, wherein the master structure of the stamping tool 13 and the master structure of the carrier then overlap in the protective varnish layer and/or in the print layer, in particular in the at least one first region. The master structure of the stamping tool 13 and of the carrier are preferably different here. For example, for this purpose the master structure on the stamping tool 13 has a different dimension from the master structure on the carrier. For example, the stamping tool 13 predefines a coarse structure in the millimeter to micrometer range and the master structure on the carrier as a fine structure in the micrometer to nanometer range is superimposed thereon, wherein a combination structure of coarse structure and fine structure is molded in the protective varnish layer and/or in the print layer.

Through the contacting of the stamping tool 13 with the protective varnish layer 8 and/or with the print layer and/or the carrier arranged in between, the master structure of the stamping tool 13 or of the carrier is molded in the protective varnish layer 8 and/or print layer at least partially, wherein a relief structure complementary to the master structure is formed in the protective varnish layer 8 and/or in the print layer, in particular in the at least one first region 5.

In particular, the protective varnish layer 8 and/or print layer is contacted with the stamping tool 13 or the carrier only in regions, preferably only where at least one first region 5 is to be arranged in the protective varnish layer 8 and/or in the print layer.

It is also possible for the stamping tool 13 and/or the carrier to have been designed such that the stamping tool 13 and/or the carrier has a master structure only in regions, wherein the protective varnish layer 8 and/or the print layer is contacted with the stamping tool 13 and/or the carrier such that the master structure contacts the protective varnish layer 8 and/or the print layer where at least one first region 5 is formed in the protective varnish layer 8 and/or in the print layer. Alternatively or additionally, the regions of the protective varnish layer 8 and/or in the print layer in which the at least one second region 6 is formed can be covered with an in particular detachable mask, for example a detachable polymer film.

Step e) is preferably effected using a stamping tool 13. For example, at least one stamping roller or at least one stamping wheel or at least one die stamp and/or at least one carrier comprising a master structure can be used as stamping tool 13.

On the surface which is contacted with the protective varnish layer 8 and/or print layer, for example its outer circumference, the stamping tool 13 preferably has a coating of an elastomer with a layer thickness selected from a range of from 3 mm to 20 mm, preferably from 5 mm to 15 mm. The elastomer is preferably silicone rubber. The elastomer preferably has a hardness selected from the range of from 30 Shore A to 95 Shore A, preferably from 60 Shore A to 90 Shore A. The optical properties of the relief structure of the at least one first region 5 can advantageously be influenced by the different Shore hardnesses.

Alternatively, it is also possible for the stamping tool 13 to have a surface made of metal, in particular which is selected from the group of brass, copper, steel or titanium.

On the circumference on its outer edges in each case the stamping wheel preferably has a bevel, wherein in particular the coating of an elastomer on the circumference on the outer edges in each case has a bevel. The bevel preferably has an angle relative to the surface normal of the circumference of the stamping wheel of between 15° and 75°, further preferably between 25° and 65°. Particularly clean edges of the stamping can be achieved with such a bevel. This means that the transition between the first region 5 and the neighboring second region 6 is largely smooth, largely straight and largely without disruptive artifacts, in particular is smooth, straight and largely without disruptive artifacts, for the unaided human eye.

The forming of the at least one first region 5 and of the at least one second region 6 is preferably effected at a stamping temperature, thus the temperature of the stamping tool 13, selected from a range of from 125° C. to 250° C.

Further, the stamping speed, thus the feed rate, has a value selected from a range of from 1 m/min to 5 m/min.

The stamping pressure, in particular in the case of up-and-down stamping, is preferably selected from a range of from 0.1 kN to 25 kN, preferably from 0.2 kN to 20 kN, particularly preferably from 0.3 kN to 15 kN.

The stamping time, in particular in the case of up-and-down stamping, is preferably selected from the range of from 0.3 s to 2.5 s, preferably from 0.5 s to 2.0 s, particularly preferably from 1.0 s to 1.5 s. In particular, the stamping time is preferably adapted to the layer thickness of the carrier.

Further, it is also possible for the stamping pressure, in particular in the case of roll stamping, preferably to be selected from a range of from 10 kg/cm² to 50 kg/cm², preferably from 15 kg/cm² to 30 kg/cm², particularly preferably 20 kg/cm² to 25 kg/cm².

For example, a good result is achieved in the case of a stamping process, in particular in the case of up-and-down stamping, with the combination of a stamping temperature of 190° C., a stamping time of 1.5 s and a stamping pressure of 15 kN.

In the case of a stamping process, in particular by means of roll stamping, a good result is achieved for example with the combination of a stamping temperature of 185° C., a stamping speed of 2 m/min, a stamping pressure of from 20 kg/cm² to 25 kg/cm² and using a stamping roller with a hardness of 80 Shore A.

The master structure has in particular a structure depth selected from a range of from 0.1 μm to 15 μm, preferably from 0.1 μm to 10 μm, particularly preferably from 0.1 μm to 5 μm. In particular, the master structure has an average structure spacing selected from the range of from 0.05 μm to 1000 μm, preferably from 0.1 μm to 100 μm, particularly preferably from 0.1 μm to 50 μm.

The complementary relief structure can have in particular a smaller structure depth than the master structure. In particular, the complementary relief structure has a structure depth which preferably corresponds to 20% to 99% of the structure depth of the master structure, particularly preferably corresponds to 40% to 95% of the structure depth of the master structure.

The master structure or the complementary relief structure can have, alone or in combination, a regular one-dimensional grating, a regular two-dimensional grating, a random structure component or a pseudo-random structure component. In particular, the complementary relief structure can have optical and/or functional effects.

A preferred one-dimensional or two-dimensional grating is a non-random relief structure which preferably has exact and geometrically formed profile shapes such as rectangular profiles, sinusoidal profiles, sawtooth profiles, hemispherical profiles or blazed structures. Furthermore, a one-dimensional or two-dimensional grating can have binary profiles or profiles with profile depth staggered in the manner of a staircase or with constant profile depth.

It is advantageous if the master structure has been designed such that the complementary relief structure comprises a microstructure, in particular a microstructure the dimensions of which lie below the resolution limit of the unaided human eye. The resolution limit of the unaided human eye preferably lies at structures with dimensions of at least 300 μm.

Further, the master structure can be designed such that the complementary relief structure comprises a macrostructure, in particular a macrostructure the dimensions of which lie above the resolution limit of the unaided human eye.

Further, the master structure can be designed such that the complementary relief structure be formed as a microstructure the dimensions of which lie below the resolution limit of the unaided human eye and additionally as a macrostructure which is visible to the unaided human eye. A macrostructure can be present next to a microstructure and/or be superimposed by a microstructure.

A microstructure can advantageously have an optical effect which simulates the presence of a macrostructure.

The master structure can be designed such that the complementary relief structure is formed as a matte structure, as a diffractive structure and/or as a refractive structure and/or as a macrostructure. Further, several of the above-named structures can also be present next to each other and/or be superimposed with each other.

Optically variable effects on the basis of the previously named structures can be realized for example by varying one or more structure parameters, for example by varying the grating period, the average structure spacing, the angle of inclination of the micromirrors, the structure depth and/or the azimuthal angle.

Preferably, the carrier comprising the master structure is only used for a small number of stampings in the same region of surface of the carrier, in particular selected from a range of from once to 20 times, preferably from once to 10 times.

In particular, it is advantageous that at least 20%, preferably at least 40%, further preferably at least 50%, still further preferably at least 70%, of the relief shape or surface structure of the master structure, in particular of the structure depth of the master structure, is and/or has been molded into the protective varnish layer 8 and/or print layer. In the finished article, the envisaged relief structure hereby has the desired optical properties.

The carrier comprising the master structure is advantageously supplied in particular in rolls and is thus able to be transported further as a carrier web. A particularly quick change of the region of surface of the carrier used for the stamping is possible here. It is further also possible to provide and to use a carrier comprising the master structure in the form of sheet material or as a board. The carrier preferably consists of or comprises polymer, for example PET. The carrier preferably has a layer thickness selected from a range of from 5 μm to 500 μm, preferably from 20 μm to 50 μm.

Alternatively, the carrier can consist of or comprise metal, for example brass, copper, steel or titanium.

For example, step e) can have at least one or more of the following substeps:
arranging and aligning the transfer film 2, preferably transfer ply 3, and the base body 9 according to the stamping tool 13 or the carrier;
heating the stamping tool 13 to stamping temperature
contacting the master structure of the stamping tool 13 or of the carrier with the transfer ply 3, in particular the protective varnish layer 8, in particular in the at least one first region 5;
moving or rotating the stamping tool 13 or the carrier.

Step e) is preferably carried out after step d) and in particular before step f). Step e) can also be carried out multiple times, in particular with differing or identical stamping tools 13 or carriers comprising identical or different master structures.

In particular, the at least one first region 5 is formed in step e) such that the transfer ply 3 has a relief structure in the at least one first region 5, wherein the relief structure is preferably complementary to the master structure of the stamping tool 13 and/or of the carrier used. The at least second region 6 preferably has no structure and is perceived as smooth and flat. In particular, the at least one first region 5 differs optically or functionally from the at least one second region, in particular by its gloss level or transmittance.

The at least one first region 5 is preferably formed in the protective varnish layer 8 and/or print layer only in regions when viewed perpendicular to a plane spanned by the protective varnish layer 8 and/or print layer. The protective varnish layer 8 and/or print layer preferably has the at least one first region 5 only in regions.

The at least one first region 5 preferably consists of one or more regions that are contiguous and/or separated from each other, in particular when viewed perpendicular to the plane spanned by the protective varnish layer 8 and/or print layer. For example, the at least one first region 5 can completely surround the at least one second region 6 and/or the at least one first region 5 can be completely surrounded by the at least one second region 6 completely. The at least one first region 5 and the at least one second region 6 have been arranged next to each other and do not overlap, in particular when viewed perpendicular to the plane spanned by the protective varnish layer 8 and/or print layer.

In particular, the design or shape of the at least one first region 5 is selected individually or in combination from: motif, letter, numeral, symbol, geometric figure, visually recognizable design element, pattern, logo, codes and strip conductor.

In particular, the at least one first region 5 is arranged in the protective varnish layer 8 and/or print layer register-accurately relative to a layer or an element of the transfer ply 3 and/or of the base body 9, in particular register-accurately relative to a decorative element 11 and/or functional element 10 arranged in the transfer ply 3 and/or base body 9. For this purpose, for example, the protective varnish layer 8 and/or print layer can be masked such that the relief structure is formed only in the unmasked at least one first region 5.

It is further possible for the protective varnish layer 8 and/or print layer of the transfer film 2 and/or of the article 1 to have a transmittance of at least 45%, preferably of at least 70%, for the wavelength range perceptible by the human eye, preferably for the range from 400 nm to 700 nm, in the at least one first region 5 and/or in the at least one second region 6.

The at least one first region 5 of the print layer, of the insert and/or of the transfer film 2, in particular of the protective varnish layer 8 or of the article 1, can have a gloss value selected from a range of from 1 GU to 59 GU, preferably from 5 GU to 30 GU, or be designed in such a way.

The at least one second region 6 of the print layer, of the insert and/or of the transfer film 2, which preferably has no relief structure, in particular of the protective varnish layer 8 or of the article 1, can have a gloss value selected from a range of from 31 GU to 98 GU, preferably from 60 GU to 90 GU.

It is possible for the method of producing the article 1 expediently further to comprise the following optional step, which is in particular carried out after step e) and before step g):
f) curing the protective varnish layer 8 and/or print layer not yet completely cured at least in regions, wherein the protective varnish layer 8 and/or print layer cures completely at least in regions.

All curable components of the article 1 are preferably completely cured in step f). Thus, the protective varnish layer and/or print layer has a high chemical and mechanical resistance in all regions after step f).

In particular, in step f) the complete curing of the protective varnish layer 8 and/or print layer is carried out by means of high-energy electromagnetic radiation, in particular UV irradiation, and/or by means of high-energy particle radiation, in particular electron beam radiation, and/or is carried out by means of curing, preferably at a temperature in a range of from 25° C. 30 to 180° C., of the protective varnish layer 8 and/or print layer.

The irradiation is preferably carried out by means of high-energy electromagnetic radiation and/or high-energy particle radiation. The electromagnetic radiation is preferably UV radiation, in particular from a wavelength range from 100 nm to 390 nm, preferably from 200 nm to 380 nm, particularly preferably from 200 nm to 300 nm. The particle radiation is preferably electron beam radiation.

For the complete curing in step f) the protective varnish layer 8 and/or print layer is irradiated with an irradiance selected from the range of from 500 mW/cm² to 700 mW/cm². The UV dose is preferably selected from the range of from 2000 mJ/cm² to 3500 mJ/cm². The irradiation is preferably effected over a period selected from the range of from 1 s to 10 s, preferably from 2 s to 6 s.

The article 1 produced using the method is obtained in step g). Thus step g) is in particular the last step of the method according to the invention and is preferably carried out after one of step e) or one of the further optional steps.

A schematic representation of the layer structure of an example article 1 is shown in FIG. 2. The article 1 has at least one protective varnish layer 8 and/or print layer of the transfer ply 3 of a transfer film 2 provided in step a) of the method, for example of a transfer film according to FIG. 1.

Alternatively, the article 1 has the insert provided according to step a2), wherein the insert has a substrate and a transfer ply 3 arranged on the substrate and/or a print layer, and wherein the transfer ply 3 comprises a protective varnish layer 8.

The protective varnish layer 8 and/or print layer has preferably been cured or is thermoplastic at least in regions and represents the surface of an article 1 facing an observer. The article 1 further has a base body 9, which is formed in step c) by back-injection molding the transfer ply 3 with a plastic material. In an alternative embodiment, the base body 9 is provided in step a2). The base body 9 has been arranged on the side of the transfer ply 3 or insert facing away from an observer. Furthermore, the protective varnish layer 8 and/or print layer of the article 1 has at least one first region 5 and at least one second region 6, which were formed in the protective varnish layer 8 and/or print layer in step e) of the method. A relief structure has been formed in the at least one first region 5.

The article 1 can further preferably have at least one decorative layer containing at least one decorative element 11, in particular in the transfer ply 3 of the transfer film 2 or of the insert, and/or at least one functional layer containing at least one functional element 10, in particular in the transfer ply 3 of the transfer film 2 or of the insert.

An article 1 produced according to the method according to the invention can be used in a large number of fields. The produced article 1 can be used for example, alone or in combination, as a display window, touch panel, panel, cover plate, cladding, cover, functional element, electronic article and housing part or outer part, in particular of white goods and/or of domestic appliances and/or of automotive interior regions and/or of automotive exterior regions.

When the method according to the invention is carried out it is possible to carry out the method steps once or multiple times. In particular, method steps can be repeated. A preferred method has at least the following steps a), e) and g), preferably a), e), f) and g), wherein further steps can in particular be inserted between these steps.

For an IMD method, the method has in particular at least the following steps in the order a1), b1), c1), d), e), g), optionally a1), b1), c1), d), e), f), g).

For an insert-molding method, the method has in particular at least the following steps in the order a2), b2, c2), e), g), optionally a2), b2, c2), e), f), g). Alternatively, the method, for an insert-molding method, has in particular at least the following steps in the order a1), h), d), b1), c1), e), g), optionally a1), h), d), b1), c1), e), f), g). It is possible for an insert-molding method to have at least the steps in the order a1), h), d), i), j), b1), c1), e), g), optionally a1), h), d), i), j), b1), c1), e), f), g).

For an injection-molding method with downstream hot-stamping method, the method has in particular at least the following steps in the order a3), k3), d), e), g), optionally a3), k3), d), e), f), g).

FIG. 3a shows a schematic intermediate product of the method of producing an article 1, wherein the intermediate product is viewed perpendicular to the plane spanned by the protective varnish layer 8. The surface of the protective varnish layer 8 thus faces the observer, wherein it has preferably not yet been completely cured at least in regions.

FIG. 3a shows the intermediate product at a time in a method wherein step e), thus the forming of at least one first region 5 and a second region 6, has not yet been carried out. The intermediate product preferably has a base body 9. In other words, step c) or step k3) of the method has already been carried out. The intermediate product has for example a transfer ply 3 according to FIG. 1 and/or can have a layer structure, such as was described above in relation to the article 1 according to FIG. 2. The intermediate product can further have the insert.

In this embodiment example, to produce the intermediate product, a transfer ply 3 was provided, which has a decorative element 11 in the form of two dashed circles on the left-hand side on and a decorative element 11 in the form of a circle interrupted by a line in the upper left-hand corner. Three further decorative elements 11 in the form of circles interrupted by lines have been arranged on the right-hand edge of the article 1. Functional elements 10 have further been arranged in the transfer ply 3 or the base body 9 preferably register-accurately relative to the above-named decorative elements 11. The functional elements 10 can have been designed for example as a control element. A further functional element 10 in the form of a display has been arranged on the right-hand side. The display can either have been arranged underneath a transparent protective varnish layer 8 or have been arranged in place of the protective varnish layer 8.

If step e) of the method is carried out now, at least one first region 5 and at least one second region 6 are formed, wherein the at least one first region 5 has a relief structure. In relation to this, FIGS. 3b to 3d show different articles 1, such as can be produced from the further processing of the intermediate product according to FIG. 2 using the method of the invention. In particular, the flexible layout design due to the method of the invention is to be presented hereby. All articles 1 have in common the fact that they have at least one first region 5 and at least one second region 6, wherein the at least one first region 5 has a relief structure, for example a matte finish. For the article according to FIG. 3e a slightly altered intermediate product is used, which differs from the intermediate product according to FIG. 3a in that it does not have a design element 11 in the form of a dashed circle, but has otherwise been designed identically.

The embodiment variants for an article 1 according to FIGS. 3b to 3e are for example a control panel of a domestic appliance, which has preferably been decorated with an IMD film in a high-gloss manner, preferably with a gloss level selected from the range of from 85 GU to 95 GU. In the at least one second region 6, in which no relief structure has been reproduced and/or in which the display window has been arranged, the protective varnish layer is thus still high-gloss. At least the protective varnish layer 8 and/or the base body 9 of the obtained article 1 has appropriately been formed transparent. The at least one first region 5 is preferably perceived as matte because of the introduced relief structure, preferably with a gloss level selected from the range of from 1 GU to 30 GU. The whole protective varnish layer 8 has a high chemical and mechanical resistance.

In the embodiment variant of the article 1 according to FIG. 3b the surface of the article has been divided, independently of decorative elements 11, into at least one first region 5 and at least one second region 6. As a result, a control region is formed on the left-hand side and a display region is formed on the right-hand side. The control region is comprised by the at least one first region 5 and the display region is comprised by the at least one second region 6.

In the article 1 according to FIG. 3c only a single decorative element 10 or functional element 11 of the transfer ply 3 has been deposited by the introduction of a relief structure in at least one first region 5, preferably register-accurately optically with respect to the at least one second region 6.

The article 1 according to FIG. 3d is comparable to the article according to FIG. 3c, wherein, however, all design elements 11 of the transfer ply 3 have been provided with at least one corresponding first region 5. The first regions 5 have preferably been arranged register-accurately relative to the design element 11 and are completely surrounded by at least one second region 6.

A further design variant for an article 1 is shown in FIG. 3e. This article 1, analogously to the articles according to FIGS. 3a to 3d, has design elements 11 and functional elements 10 arranged in the transfer film 3, for example control elements and a display. However, a circular first region 5 has been arranged such that it has been arranged not register-accurately relative to a design element 11, but only relative to a functional element 10. Due to such a design, a functional element 10 of the article 1 can be optically emphasized and made recognizable for an observer without a corresponding decorative element 11 having to be present in the transfer ply 3. It is additionally possible to arrange, through a further step e), at least one further first region 5, which has a further relief structure differing from the first at least one first region 5, in the region in which the functional element 10 in the form of a display has been arranged. For example, the relief structure can provide an “anti-glare” effect in order to improve the readability of the display.

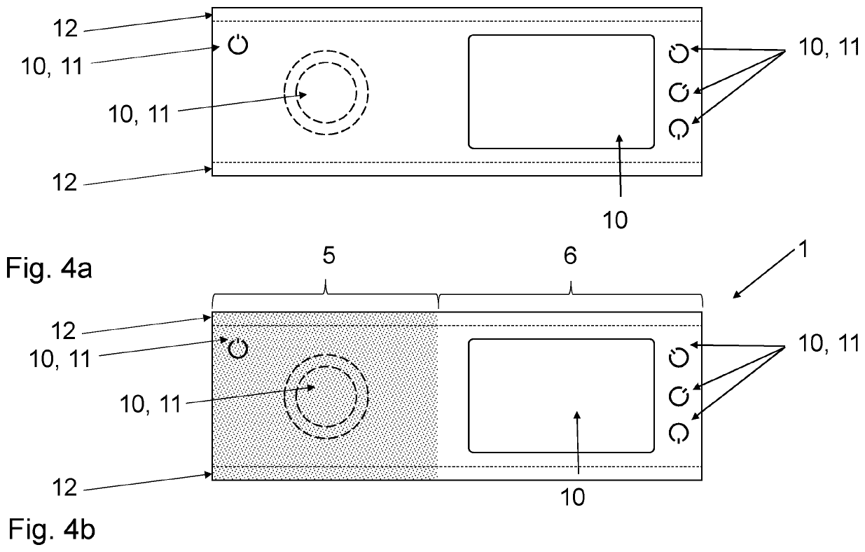

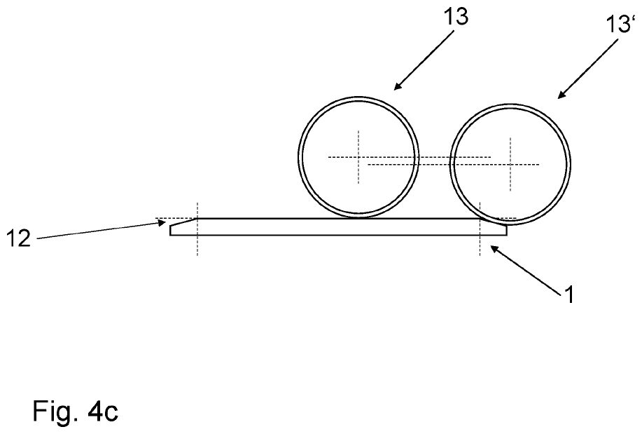

A further design variant for an article 1 is shown in FIGS. 4a and 4b. This article 1, analogously to the articles according to FIGS. 3a to 3d, has design elements 11 and functional elements 10 arranged in the transfer film 3, for example control elements and a display. However, on two opposite sides the article 1 has a bevel, which bevels are at approx. 15° relative to the other (horizontal, flat) surface of the article 1 in the example shown. The boundary between bevel and the other surface of the article 1 is represented as a dashed line. The first region 5 has been provided both on the flat surface of the article 1 and on the bevels 12 such that the first region 5 has been arranged uninterrupted between the opposite outer edges of the article 1. A side view of the article 1 according to FIGS. 4a and 4b has been represented in FIG. 4c in order to demonstrate by way of example how the first region 5 is arranged by means of stamping tool 13. The stamping tool 13, here a stamping wheel, is made correspondingly height-adjustable corresponding to the article contour with lower-lying bevels 12 and high-lying flat surface, with the result that approximately the same stamping pressure can be exerted on all regions of the article 1 to generate a uniformly made and uninterrupted first region 5. The height adjustment can be performed by means of one or more servo motors or via pneumatic control. FIG. 4c schematically shows the position of the stamping tool 13 or its axis of rotation during the stamping of the flat surface of the article 1 as well as a possible position, dependent on the contour of the article 1, of the stamping tool 13′ or its axis of rotation during the stamping of the lower-lying bevel 12.

Of course, the listed embodiment variants can be combined with each other as desired and do not represent a limitation.

### LIST OF REFERENCE NUMBERS

1 article
2 transfer film
3 transfer ply
4 carrier ply
5 first region
6 second region
7 carrier layer
8 protective varnish layer
9 base body
10 functional element
11 decorative element
12 bevel
13, 13′ stamping tool

1. A method of producing an article, wherein the method comprises at least one of the steps A1) or A2) or A3),
wherein step A1) comprises the following steps:
a1) providing a transfer film, wherein the transfer film has a carrier ply and a transfer ply, wherein the carrier ply can be peeled off the transfer ply, wherein the carrier ply comprises a carrier layer, wherein the transfer ply comprises a protective varnish layer, and wherein the protective varnish layer has been arranged such that it is in contact with the carrier ply;
b1) arranging the transfer film in an injection mold;
c1) back-injection molding the transfer film with a plastic material, wherein the plastic material forms a base body;
d) detaching the carrier ply from the transfer ply;
wherein step A2) comprises the following steps:
a2) providing an insert, wherein the insert has a substrate and, arranged on the substrate, a transfer ply and/or a print layer, wherein the transfer ply comprises a protective varnish layer;
b2) arranging the insert in an injection mold;
c2) back-injection molding the insert with a plastic material, wherein the plastic material forms a base body;
wherein step A3) comprises the following steps:
a3) providing a transfer film, wherein the transfer film has a carrier ply and a transfer ply, wherein the carrier ply can be peeled off the transfer ply, wherein the carrier ply comprises a carrier layer, wherein the transfer ply comprises a protective varnish layer and wherein the protective varnish layer has been arranged such that it is in contact with the carrier ply
and providing, separately from the transfer film, a base body;
k3) arranging the transfer film on a surface of the base body and hot stamping the transfer film onto the surface of the base body;
d) detaching the carrier ply from the transfer ply;
wherein the protective varnish layer and/or the print layer has not yet been completely cured or is thermoplastic at least in regions in steps A1) or A2) or A3), and wherein the method comprises the following steps in addition to at least one of the steps A1) or A2) or A3):
e) forming at least one first region and at least one second region in the protective varnish layer and/or in the print layer by means of stamping, wherein the at least one first region has a relief structure;
g) obtaining an article, wherein the article comprises a base body and a protective varnish layer and/or print layer, which has been cured or is thermoplastic at least in regions, wherein the protective varnish layer and/or print layer has at least one first region and at least one second region, wherein a relief structure has been arranged in the at least one first region.

2. The method according to claim 1, wherein
the method further comprises at least one of the following step h), i) and j):
h) arranging the transfer film on a substrate;
i) shaping the transfer film and/or the substrate into a desired shape; and
j) trimming the transfer film and/or the substrate along a defined contour line.

3. The method according to claim 1, wherein
a complete curing of the protective varnish layer and/or print layer is carried out by means of high-energy electromagnetic radiation, and/or by means of high-energy particle radiation, and/or is carried out by means of curing of the protective varnish layer and/or print layer.

4. The method according to claim 1, wherein a curing of the protective varnish layer and/or the print layer
is carried out with an irradiance selected from the range of from 500 mW/cm² to 700 mW/cm², and/or wherein the irradiation is effected over a period selected from the range of from 1 s to 10 s.

5. The method according to claim 1, wherein
the transfer ply is provided such that the protective varnish layer not yet cured in regions comprises at least one UV-crosslinkable and/or at least chemically crosslinkable polymer.

6. The method according to claim 5, wherein
the at least one chemically crosslinkable polymer is selected from the group which consists of isocyanate-group-containing polymers, melamine-containing polymers, hydroxyl-group-containing polymers and mixtures thereof.

7. The method according to claim 5, wherein
the at least one chemically crosslinkable polymer has a polymer combination which comprises or is a polymer and/or copolymer with at least one isocyanate group and at least one polymer and/or copolymer with at least one hydroxyl group and/or at least one melamine resin and at least one polymer and/or copolymer with at least one hydroxyl group.

8. The method according to claim 7, wherein
the at least one UV-crosslinkable polymer has at least one chemically crosslinkable functional group.

9. The method according to claim 1, wherein
the transfer film provided in step a) comprises at least one decorative layer containing at least one decorative element and/or at least one functional layer containing at least one functional element.

10. The method according to claim 9, wherein
the at least one decorative element containing by the at least one decorative layer is selected from the group which consists of transparent and/or colored varnish layers, replication layers with a molded optically active surface structure, reflective layers, optically variable layers, optically active layers, interference multilayer systems, volume hologram layers, liquid crystal layers, and
combinations thereof.

11. The method according to claim 9, wherein
the at least one functional element is selected from the group which consists of at least one electronic element, antenna, memory, display, control element, processor, capacitor, resistor, microfluidic element and combinations thereof.

12. The method according to claim 1, wherein
an adhesion-promoter layer has been arranged between the protective varnish layer and the at least one decorative element and/or the at least one functional element.

13. The method according to claim 1, wherein
the transfer ply has at least one varnish layer, which forms a surface of the transfer ply facing away from the carrier ply.

14. The method according to claim 1, wherein
the carrier ply has at least one detachment layer.

15. The method according to claim 1, wherein
step e) is carried out by means of hot stamping, wherein step e) comprises the use of a stamping tool.

16. The method according to claim 15, wherein
a carrier comprising a master structure is arranged between the stamping tool and the transfer ply and/or between the stamping tool and the print layer at least in regions.

17. The method according to claim 15, wherein
the stamping tool has a master structure.

18. The method according to claim 15, wherein
the protective varnish layer and/or the print layer is contacted with the stamping tool.

19. The method according to claim 15, wherein
the stamping tool has no master structure and/or is smooth.

20. The method according to claim 16, wherein
through the contacting of the stamping tool with the protective varnish layer and/or with the print layer or the carrier arranged in between, the master structure of the stamping tool or of the carrier is molded in the protective varnish layer and/or in the print layer at least partially, wherein a relief structure complementary to the master structure is formed in the protective varnish layer and/or in the print layer.

21. The method according to claim 16, wherein
the master structure or the complementary relief structure is selected, alone or in combination, from a regular one-dimensional, a regular two-dimensional grating, a random structure component and a pseudo-random structure component.

22. The method according to claim 16,
wherein
the master structure has a structure depth selected from a range of from 0.1 μm to 15 μm, and/or wherein the master structure has an average structure spacing selected from a range of from 0.05 μm to 1000 μm.

23. (canceled)

24. The method according to claim 16, wherein
the carrier comprises or consists of polymer.

25. The method according to claim 16,
the protective varnish layer and/or the print layer is contacted with the stamping tool or the carrier only in regions.

26. The method according to claim 6, wherein
the stamping tool and/or the carrier has been designed such that the stamping tool and/or the carrier has the master structure only in regions, wherein the protective varnish layer and/or the print layer is contacted with the stamping tool and/or the carrier such that the master structure contacts the protective varnish layer and/or the print layer where at least one first region is arranged in the protective varnish layer and/or in the print layer.

27. (canceled)

28. The method according to claim 1, wherein
the forming of the at least one first region and of the at least one second region is effected at a stamping temperature selected from the range of from 125° C. to 250° C., and/or wherein the stamping speed has a value selected from the range of from 1 m/min to 5 m/min.

29. The method according to claim 1, wherein
in step e) a stamping pressure is selected from a range of from 0.1 kN to 25 kN, and/or wherein a stamping pressure is selected from a range of from 10 kg/cm² to 50 kg/cm².

30. The method according to claim 1, wherein
the at least one first region is formed in the protective varnish layer and/or in the print layer register-accurately relative to a layer or an element of the transfer ply and/or of the base body.

31. The method according to claim 1, wherein
the at least one first region of the print layer and/or of the insert and/or of the transfer film (2) is designed such that it has a gloss value in a range of from 1 GU to 59 GU.

32. An article comprising a base body and a protective varnish layer and/or a print layer, wherein the protective varnish layer and/or the print layer has been completely cured or is thermoplastic at least in regions, wherein the protective varnish layer and/or the print layer has at least one first region and at least one second region, wherein a relief structure has been arranged in the at least one first region, and wherein the article was produced according to claim 1.

33. (canceled)
